(19) United States
(12) Patent Application Publication
(10) Pub. No.: US 2025/0097920 A1
(43) Pub. Date: Mar. 20, 2025

(54) TRANSMITTER SWITCHING AND SWITCHING GAPS FOR WIRELESS COMMUNICATIONS

(71) Applicant: ZTE Corporation, Shenzhen (CN)

(72) Inventors: Jing SHI, Shenzhen (CN); Xianghui HAN, Shenzhen (CN); Xingguang WEI, Shenzhen (CN); Shuaihua KOU, Shenzhen (CN); Min REN, Shenzhen (CN); Wei GOU, Shenzhen (CN)

(73) Assignee: ZTE Corporation, Shenzhen, GD (CN)

(21) Appl. No.: 18/899,635

(22) Filed: Sep. 27, 2024

Related U.S. Application Data
(63) Continuation of application No. PCT/CN2022/123437, filed on Sep. 30, 2022.

(51) Int. Cl. H04W 72/0453

(52) U.S. Cl. CPC H04W 72/0453

(57) ABSTRACT

This document generally relates to wireless communication involving a communication device that determines a switching gap based on at least one switching period of at least one band pair of at least three bands involved in an uplink (UL) transmitter (Tx) switching. In addition, a user device transmits, and a network device receives, an UL transmission after the UL Tx switching and/or a preceding UL transmission before the UL Tx switching according to the switching gap. In addition, this document relates to a user device that determines a restriction for a PDCCH monitoring capability, and reports a UE capability of the PDCCH monitoring capability with the restriction.

### CROSS-REFERENCE TO RELATED APPLICATION(S)

The present application is a continuation of International Patent Application No. PCT/CN2022/123437, filed Sep. 30, 2022. The contents of International Patent Application No. PCT/CN2022/123437 are herein incorporated by reference in their entirety.

### TECHNICAL FIELD

This document is directed generally to transmitter switching and switching gaps in wireless communication.

### BACKGROUND

In wireless communication, a user device may perform uplink (UL) transmitter (Tx) switching within up to two bands. In addition, for multi-carrier operation, a user device that transmits with two transmitters (also called a 2Tx user device), may transmit in at most two UL bands. Which two bands that are used may only be changed by radio resource control (RRC) reconfiguration. In addition, a 2Tx user device may only perform UL Tx switching between two UL bands. However, current UL Tx switching schemes may not allow a user device to perform UL Tx switching with three or four bands and simultaneous transmission with two transmitters, to enable more configured UL bands than its simultaneous transmission capability, and/or to support dynamic Tx carrier switching across configured bands. UL Tx switching schemes involving three or more bands and switching gap determinations that overcome these deficiencies may be desirable.

### SUMMARY

This document relates to methods, systems, apparatuses and devices for wireless communication. In some implementations, a method for wireless communication includes: determining, by a communication device, a switching gap based on at least one switching period of at least one band pair of at least three bands involved in an uplink (UL) transmitter (Tx) switching; and transmitting, by a user device, an UL transmission after the UL Tx switching according to the switching gap.

In some other implementations, a method for wireless communication includes: determining, by a communication device, a switching gap based on at least one switching period of at least one band pair of at least three bands involved in an uplink (UL) transmitter (Tx) switching; and receiving, by a network device, an UL transmission after a preceding UL transmission based on a switching gap.

In some other implementations, a method for wireless communication includes: determining, by a user device, a restriction for a PDCCH monitoring capability; and reporting, by the user device, a user equipment (UE) capability of the PDCCH monitoring capability with the restriction.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of transceiver and antenna components of a user device of FIG. 1.

FIG. 3 shows a block diagram illustrating relationships between carriers, bands, and cells.

FIG. 4 is a time mask for switching between two UL carriers.

FIG. 5 is another time mask for switching between two UL carriers.

FIG. 6 is a flow chart of an example method for wireless communication.

FIG. 7 is a flow chart of an example method for wireless communication.

FIG. 8 is a schematic diagram illustrating an example switching case.

FIG. 9 is a flow chart of an example method for wireless communication.

FIG. 10 is a chart of example UE capability.

FIG. 11 is a chart of example UE capability.

FIG. 12 is a chart of example UE capability.

FIG. 13 is a chart of example UE capability.

FIG. 14 is a chart of example UE capability.

FIG. 15 is a chart of example UE capability.

FIG. 16 is a chart of example UE capability.

FIG. 17 is a diagram of PUSCH transmissions and an uplink transmission in different cells within a nominal time domain window (TDW).

FIG. 18 is a diagram of PUSCH transmissions and two uplink transmissions in different cells within a nominal TDW.

### DETAILED DESCRIPTION

The present description describes various embodiments of systems, apparatuses, devices, and methods for wireless communications related to uplink (UL) transmitter (Tx) switching and switching gaps.

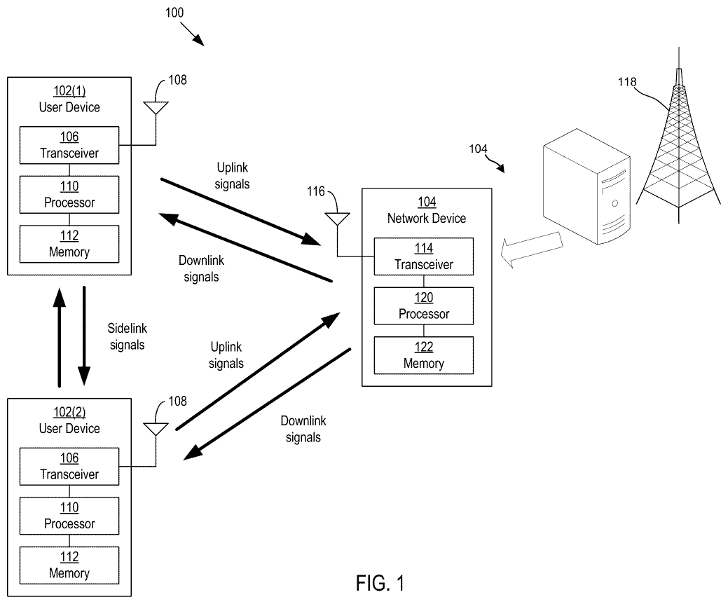

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to a another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

In addition, in some embodiments, a user device 102 may be configured to support at least one simultaneous UL transmission mode across a band pair for UL transmissions. In a first simultaneous UL transmission mode (also called a switchedUL mode), the user device 102 does not support simultaneous UL transmission across a band pair. Accordingly, when the user device 102 transmits an UL transmission in the first simultaneous UL transmission mode, the user device 102 transmits the UL transmission without simultaneously transmitting across a band pair. In addition, in a second simultaneous UL transmission mode (also called a dualUL mode), the user device 102 supports simultaneous UL transmission across a band pair. Accordingly, when the user device 102 transmits an UL transmission in the second simultaneous UL transmission mode, the user device 102 may transmit the UL transmission by simultaneously transmitting across a band pair.

Also, for at least some embodiments, as used herein, the first and second UL simultaneous transmission modes may be referred to as, or otherwise correspond to, carrier aggregation (CA) options. For example, the first simultaneous UL transmission (or switchedUL) mode may also be referred to, or correspond to, a first CA option or a switchedUL CA option. The second simultaneous UL transmission (or dualUL) mode may also be referred to, or correspond to, a second CA option or a dualUL CA option. Correspondingly, when a user device 102 operates with the switchedUL CA option, the user device 102 does not support and/or perform simultaneous UL transmission across a band pair. When a user device 102 operates with the dualUL CA option, the user device 102 supports and/or performs simultaneous UL transmission across a band pair.

Also, in some embodiments, the user device 102 may report the simultaneous UL transmission mode(s) to the network device 104. That is, the user device 102 may report, to the network device 104, that it supports simultaneous UL transmission across a band pair, that it does not support simultaneous UL transmission across a band pair, or that it both supports and does not support simultaneous UL transmission across a band pair. In particular of these embodiments, the user device 102 may report whether or not it supports simultaneous UL transmission across a band pair per Band Combination (BC). Also, the network device 104 may configured the simultaneous UL transmission mode (e.g., switchedUL or dualUL) per cell group, which may be considered as per BC or per band pair in embodiments where a 2Tx user device supports only two bands. That is, one available band pair in a Band Combination may support one simultaneous UL transmission mode.

Additionally, in general as used herein, a Band Combination and a band group may each include a plurality of bands. In some embodiments, a band combination includes five or more bands. In addition or alternatively, a band group may include up to three or four bands. In addition or alternatively, a given band group may be included in or part of a Band Combination. Also, a Band Combination and/or a band group may include at least one band pair, where a band pair includes two bands.

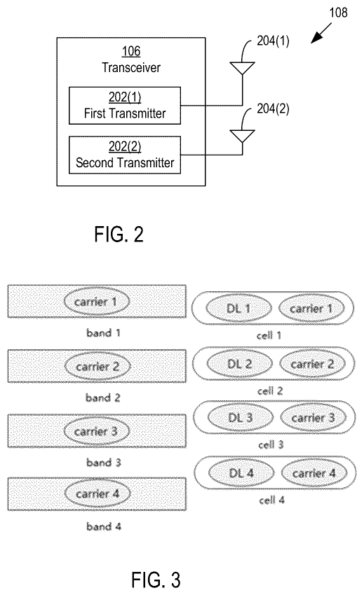

FIG. 2 shows a block diagram of an example configuration of the transceiver 106 and the antenna 108. In particular, the transceiver 106 includes a first transmitter circuit 202(1) and a second transmitter circuit 202(2). In addition, the antenna 108 may include a first antenna component 204(1) and a second antenna component 204(2). In general, the first transmitter circuit 202(1) and the first antenna component 204(1) may form a first transmitter channel or chain, and the second transmitter circuit 202(2) and the second antenna component 204(2) may form a second transmitter channel or chain. A user device 102, with the configuration in FIG. 2, may be configured to transmit a first UL transmission (or a first part of an UL transmission) using the first transmitter channel, and may be configured to transmit a second UL transmission (or a second part of a UL transmission) using the first transmitter channel. Also, as used herein, and unless specified otherwise, the term “transmitter” is used to refer to a transmitter circuit alone, an antenna component alone, or a combination of a transmitter circuit and an antenna component (i.e., a transmitter channel or chain).

Additionally, in various embodiments, the user device 102 may use the two transmitter channels to transmit on one or two bands or carriers. The user device 102 may do so in any of various ways. For example, the user device 102 may transmit on a single carrier using both the first transmit channel and the second transmit channel. As another example, the user device 102 may transmit on a first carrier using the first transmit channel and on a second carrier using the second transmit channel. As used herein, the terms “1 Tx” and “1T” refer to use of one channel to transmit on one carrier, and the terms “2 Tx” and “2T” refer to the use of two transmit channels to transmit on one carrier.

In addition, as used herein, the phrase “UL transmit case” refers to a particular configuration of the transmit channels used for an UL transmission on one or more carriers. Also, as described in further detail below, the user device 102 may switch between UL transmit cases during an UL Tx switching operation. Table 1 below lists two example UL transmit cases, Case 1 and Case 2.

TABLE 1
Example of UL Transmit Cases

| | |
|---|---|
| Case 1 | 1 Tx on carrier 1 and 1 Tx on carrier 2 |
| Case 2 | 0 Tx on carrier 1 and 2 Tx on carrier 2 |

Table 1 shows that for a first UL transmit case (Case 1), the user device 102 transmits an UL transmission on two carriers, using one transmit channel (1 Tx) for each carrier, such as by using a first transmitter to transmit on a first carrier (carrier 1) and a second transmitter to transmit on a second carrier (carrier 2). In addition, Table 1 shows that for a second UL transmit case (Case 2), the user device 102 transmits an UL transmission on only one carrier, using two transmitters (2 Tx) to transmit on the second carrier. For this second case, the user device 102 does not use any transmit channels to transmit on the first carrier.

In addition, in various embodiments, the user device 102 may perform UL transmitter (Tx) switching to perform UL transmissions. In general, the user device 102 may perform UL Tx switching by switching from one UL transmit case to another UL transmit case. In operation, the user device 102 may transmit an UL transmission according to a first UL transmit case, and then may switch from the first UL transmit case to a second UL transmit case, and transmit an UL transmission according to the second UL transmit case. To illustrate, using Table 1 for example, the user device may transmit an UL transmission according to Case 1, such as by transmitting on the first carrier using the first transmitter and transmitting on the second carrier using the second transmitter. Then, the user device 102 may switch from Case 1 to Case 2, and then transmit an UL transmission according to Case 2, such as by transmitting on the second carrier using both the first and second transmitters.

In various embodiments, such as with reference to Table 1, a type of UL Tx switching that the user device 102 performs may be referred to as 1Tx-2Tx switching. For 1Tx-2Tx switching, the user device 102 may switch from using one transmitter to transmit on a carrier to using two transmitters to transmit on a carrier, or may switch from using two transmitters to one transmitter to transmit on a channel.

In addition, in various embodiments, UL transmit cases may also identify numbers of antenna ports corresponding to the carriers. The identification may be in the form of a mapping between carriers and respective numbers of antenna ports. For at least some of these embodiments, the numbers of antennas may depend on whether or not the user device 102 supports simultaneous transmission across a band pair. Table 2 shows example UL transmit cases when simultaneous transmission across a band pair is not supported, and further when the user device 102 applies carrier aggregation including a supplementary UL (SUL) band.

TABLE 2
Example of UL Transmit Cases with Antenna Port
Number Mapping where UE does not support simultaneous
transmission across a band pair

| | | Number of antenna ports |
|---|---|---|
| | Number of Tx chains in WID | for UL transmission |
| | (carrier 1 + carrier 2) | (carrier 1 + carrier 2) |
| Case 1 | 1T + 1T | 1P + 0P |
| Case 2 | 0T + 2T | 0P + 2P, 0P + 1P |

In the example illustrated in Table 2, for a first UL transmit case (Case 1), the user device 102 transmits on the first carrier using the first transmitter, and transmits on the second carrier using the second transmitter. Also, based on that the user device 102 does not support simultaneous transmission across a band pair, the number of antenna ports for the UL transmission on the first carrier is one, and the number of antenna ports for the UL transmission on the second carrier is zero (1P+0P). Additionally, in the example illustrated in Table 2, for a second UL transmit case (Case 2), the user device 102 transmits on the second carrier using both the first and second transmitters. Also, based on that the user device 102 does not support simultaneous transmission across a band pair, the numbers of antenna ports for the two carriers can be one of two options. In a first option, the number of antenna ports for the first carrier is zero, and the number of antenna ports for the second carrier is two. In a second option, the number of antenna ports for the first carrier is zero, and the number of antenna ports for the second carrier is one.

Table 3 shows example UL transmit cases when simultaneous transmission across a band pair is supported.

TABLE 3
Example of UL Transmit Cases with Antenna Port Number Mapping
where UE supports simultaneous transmission across a band pair

| | | Number of antenna ports |
|---|---|---|
| | Number of Tx chains in WID | for UL transmission |
| | (carrier 1 + carrier 2) | (carrier 1 + carrier 2) |
| Case 1 | 1T + 1T | 1P + 0P, 1P + 1P, 0P + 1P |
| Case 2 | 0T + 2T | 0P + 2P, 0P + 1P |

In the example illustrated in Table 3, for a first UL transmit case (Case 1), the user device 102 transmits on the first carrier using the first transmitter, and transmits on the second carrier using the second transmitter. Also, based on that the user device 102 does support simultaneous transmission across a band pair, the number of antenna ports for the UL transmission can be one of three options. In a first option, the number of antenna ports for the first carrier is one, and the number of antenna ports for the second carrier is zero. In a second option, the numbers of antenna ports for the first and second carriers are each one. In a third option, the number of antenna ports for the first carrier is zero, and the number of antenna ports for the second carrier is one. In a second UL transmit case, the user device 102 does not transmit on the first carrier with any transmitters, and transmits on the second carrier with two transmitters. Also, based on that the user device 102 does support simultaneous transmission across a band pair, the number of antenna ports for the UL transmission can be one of two options. In a first option, the number of antenna ports for the first carrier is zero, and the number of antenna ports for the second carrier is two. In a second option, the number of antenna ports for the first carrier is zero, and the number of antenna ports for the second carrier is one.

As mentioned above, the user device 102 may perform 1Tx-2Tx UL Tx switching, where the user device 102 switches between one and two transmitters for transmitting on a channel. Another type of UL Tx switching may include 2Tx-2Tx switching, where the user device 102 switches from using two transmitters to transmit on a carrier to using two transmitters to transmit on another carrier. Tables 4 and 5 below illustrate examples of 2Tx-2Tx UL Tx switching.

TABLE 4
First Example of UL Transmit Cases for 2Tx-2Tx Switching

| | Number of Tx chains in WID (carrier 1 + carrier 2) |
|---|---|
| Case 1 | 0T + 2T |
| Case 2 | 2T + 0T |

TABLE 5
Example of UL Transmit Cases combining
1Tx-2Tx and 2Tx-2Tx Switching

| | Number of Tx chains in |
|---|---|
| | WID (carrier 1 + carrier 2) |
| Case 1 | 1T + 1T |
| Case 2 | 0T + 2T |
| Case 3 | 2T + 0T |

With reference to Table 4, in the first example of 2Tx-2Tx UL Tx switching, in a first transmit case (Case 1), the user device 102 transmits on a second carrier using two transmitters, and does not transmit on a first carrier with any transmitters. In a second transmit case (Case 2), the user device 102 transmits on the first carrier using two transmitters, and does not transmit on the second carrier with any transmitters. For the 2Tx-2Tx UL Tx switching, the user device 102 may switch from the first transmit case to the second transmit case, or may switch from the second transmit case to the first transmit case.

With reference to Table 5, the user device 102 may use a combination of 1Tx-2Tx switching and 2Tx-2Tx switching. For example, in Table 5, Case 1 corresponds to Case 1 in Table 2, and Cases 2 and 3 correspond to Cases 1 and 2 in Table 4, respectively. The user device 102 may perform 1Tx-2Tx switching by switching between Cases 1 and 2 and/or Cases 1 and 3, and may perform 2Tx-2Tx switching by switching between Cases 2 and 3.

Also, in various embodiments, UL transmit cases may also identify numbers of antenna ports corresponding to the carriers for 2Tx-2Tx switching, such as in the form of mapping between carriers and respective numbers of antenna ports, similar to Tables 2 and 3 above, which shows mapping between carriers and numbers of antenna ports for 1Tx-2Tx switching. The mappings may depend on whether the user device 102 supports or does not support simultaneous switching across a band pair. Table 6, below, shows example UL transmit cases with numbers of antenna ports mapping for 2Tx-2Tx switching where the user device 102 does not support simultaneous transmission across a band pair. Table 7, below, shows example UL transmit cases with numbers of antenna port mapping for 2Tx-2Tx switching where the user device 102 supports simultaneous transmission across a band pair.

TABLE 6
Example of UL Transmit Cases with Antenna Port Number
Mapping for 2Tx-2Tx switching, where UE does not support
simultaneous transmission across a band pair

| | Number of Tx | Number of antenna ports |
|---|---|---|
| | chains in WID | for UL transmission |
| | (carrier 1 + carrier 2) | (carrier 1 + carrier 2) |
| Case 2 | 0T + 2T | 0P + 2P, 0P + 1P |
| Case 3 | 2T + 0T | 2P + 0P, 1P + 0P |

TABLE 7
Example of UL Transmit Cases with Antenna Port Number Mapping
for combination of 1Tx-2Tx and 2Tx-2Tx switching, where UE
supports simultaneous transmission across a band pair

| | Number of Tx | Number of antenna ports |
|---|---|---|
| | chains in WID | for UL transmission |
| | (carrier 1 + carrier 2) | (carrier 1 + carrier 2) |
| Case 1 | 1T + 1T | 1P + 0P, 1P + 1P, 0P + 1P |
| Case 2 | 0T + 2T | 0P + 2P, 0P + 1P |
| Case 3 | 2T + 0T | 2P + 0P, 1P + 0P |

Additionally, in various embodiments, the user device 102 may perform 1Tx-2Tx and/or 2Tx-2Tx UL Tx switching with respect to bands. For example, one carrier may be on one band (e.g., a Band A), and two carriers, such as two contiguous carriers, may be on another band (e.g., a Band B). For at least some of these embodiments, the band with the one carrier may be a supplementary UL (SUL) band, and the band with the two contiguous carriers may be a non-SUL or a normal UL (NUL) band. For at least some of these examples, the user device 102 may perform UL Tx switching between any two or three of the following cases for a first Band And a second band (i.e., Band A+Band B): Case 1: 1T+1T; Case 2: 0T+2T; Case 3: 2T+0T.

Additionally, for embodiments where the user device 102 performs UL Tx switching with respect to bands, the UL transmit cases may identify numbers of antenna ports for the carriers of the bands, similar to Tables 2, 3, 6 and 7 above. Tables 8-11 show various UL transmit cases with of antenna port number mapping for two bands including three carriers, where a first band (Band A) includes one carrier and a second band (Band B) includes two contiguous carriers. Table 8 shows example UL transmit cases for 1Tx-2Tx UL Tx switching where the user device 102 does not support simultaneous transmission across a band pair. Table 9 shows example UL transmit cases for 1Tx-2Tx UL Tx switching where the user device 102 supports simultaneous transmission across a band pair. Table 10 shows example UL transmit cases for 2Tx-2Tx UL Tx switching where the user device 102 does not support simultaneous transmission across a band pair. Table 11 shows example UL transmit cases for 2Tx-2Tx UL Tx switching where the user device 102 supports simultaneous transmission across a band pair.

TABLE 8
Example UL transmit cases with Antenna Port Number
Mapping for 1Tx-2Tx switching where UE does not support
simultaneous transmission across a band pair

| | | Number of antenna ports |
|---|---|---|
| | Number of Tx | for UL transmission (Band |
| | chains in WID | A (carrier 1) + Band B |
| | (Band A + Band B) | (carrier 2 + carrier 3)) |
| Case 1 | 1T + 1T | 1P + (0P + 0P) |
| Case 2 | 0T + 2T | 0P + (2P + 0P), 0P + (0P + 2P), |
| | | 0P + (2P + 2P), 0P + (1P + 0P), |
| | | 0P + (0P + 1P), 0P + (1P + 1P), |
| | | 0P + (1P + 2P), 0P + (2P + 1P) |

TABLE 9
Example UL transmit cases with Antenna Port Number
Mapping for 1Tx-2Tx switching where UE supports
simultaneous transmission across a band pair

| | | Number of antenna ports |
|---|---|---|
| | Number of Tx | for UL transmission (Band |
| | chains in WID | A (carrier 1) + Band B |
| | (Band A + Band B) | (carrier 2 + carrier 3)) |
| Case 1 | 1T + 1T | 1P + (0P + 0P), 1P + (1P + 0P), |
| | | 1P + (0P + 1P), 1P + (1P + 1P), |
| | | 0P + (1P + 0P), 0P + (0P + 1P), |
| | | 0P + (1P + 1P) |
| Case 2 | 0T + 2T | 0P + (2P + 0P), 0P + (0P + 2P), |
| | | 0P + (2P + 2P), 0P + (1P + 0P), |
| | | 0P + (0P + 1P), 0P + (1P + 1P), |
| | | 0P + (1P + 2P), 0P + (2P + 1P) |

TABLE 10
Example UL transmit cases with Antenna Port Number
Mapping for 2Tx-2Tx switching where UE does not support
simultaneous transmission across a band pair

| | | Number of antenna ports |
|---|---|---|
| | Number of Tx | for UL transmission (Band |
| | chains in WID | A (carrier 1) + Band B |
| | (Band A + Band B) | (carrier 2 + carrier 3)) |
| Case 2 | 0T + 2T | 0P + (2P + 0P), 0P + (0P + 2P), |
| | | 0P + (2P + 2P), 0P + (1P + 0P), |
| | | 0P + (0P + 1P), 0P + (1P + 1P), |
| | | 0P + (1P + 2P), 0P + (2P + 1P) |
| Case 3 | 2T + 0T | 2P + (0P + 0P), 1P + (0P + 0P) |

TABLE 11
Example UL transmit cases with Antenna Port Number
Mapping for 2Tx-2Tx switching where UE supports
simultaneous transmission across a band pair

| | | Number of antenna ports |
|---|---|---|
| | Number of Tx | for UL transmission (Band |
| | chains in WID | A (carrier 1) + Band B |
| | (Band A + Band B) | (carrier 2 + carrier 3)) |
| Case 1 | 1T + 1T | 1P + (0P + 0P), 1P + (1P + 0P), |
| | | 1P + (0P + 1P), 1P + (1P + 1P), |
| | | 0P + (1P + 0P), 0P + (0P + 1P), |
| | | 0P + (1P + 1P) |
| Case 2 | 0T + 2T | 0P + (2P + 0P), 0P + (0P + 2P), |
| | | 0P + (2P + 2P), 0P + (1P + 0P), |
| | | 0P + (0P + 1P), 0P + (1P + 1P), |
| | | 0P + (1P + 2P), 0P + (2P + 1P) |
| Case 3 | 2T + 0T | 2P + (0P + 0P), 1P + (0P + 0P) |

Also, in various embodiments, the user device 102 may be configured with three bands for which to perform UL Tx switching and within which to transmit UL transmissions. The three bands may include a first band (Band A), a second band (Band B), and a third band (Band C). For at least some of these embodiments, the user device 102 may dynamically select any two of these three bands to perform UL Tx switching. In various of these embodiments, the three bands may include various combination of SUL bands and normal or non-SUL (NUL) bands, examples of two scenarios are as follows.

In a first scenario (Scenario 1): Band A is a SUL band or a non-SUL band, Band B is a non-SUL band, and Band C is a SUL band or a non-SUL band. That is, Band C is similar as Band A. In one example of Scenario 1, Band A includes a first carrier (carrier 1), Band B includes a second carrier (carrier 2), and Band C includes a third carrier (carrier 3). In a second example of Scenario 1, Band A includes carrier 1, Band B includes carriers 2 and 3, and Band C includes a fourth carrier (carrier 4).

In a second scenario (Scenario 2), Band A is a SUL Band or a non-SUL Band, Band B is a non-SUL Band, and Band C is a non-SUL Band. That is, Band C is similar as Band B. In one example of Scenario 2, Band A includes carrier 1, Band B includes carrier 2, and Band C includes carriers 3 and 4. In a second example of Scenario 2, Band A includes carrier 1, Band B includes carriers 2 and 3, and Band C includes carrier 4 and a fifth carrier (carrier 5).

Additionally, in various other embodiments, the user device 102 may be configured with four bands, including a first band (Band A), a second band (Band B), a third band (Band C), and a fourth band (Band D), for which to perform UL Tx switching and within which to transmit UL transmissions. Similar to the three-Band Configurations, the user device 102 may dynamically select any two of the four bands to perform UL Tx switching. In various of these embodiments, the four bands may include various combinations of SUL and NUL bands, examples of two scenarios are as follows.

In a first scenario (Scenario 1), Band A is a SUL band or a non-SUL band, Band B is a non-SUL band, and Band C is a SUL band or a non-SUL band. That is, Band C is similar as Band A. In a first example of Scenario 1, band includes a first carrier (carrier 1), Band B includes a second carrier (carrier 2), Band C includes a third carrier (carrier 3), and Band D includes a fourth carrier (carrier 4). In a second example of Scenario 1, Band A includes carrier 1, Band B includes carrier 2, Band C includes carrier 3, and Band D includes carrier 4 and a fifth carrier (carrier 5). In a third example of Scenario 1, Band A includes carrier 1, Band B includes carriers 2 and 3, Band C includes carrier 4, and Band D includes carrier 5. In a fourth example of Scenario 1, Band A includes carrier 1, Band B includes carriers 2 and 3, Band C includes carrier 4, and Band D includes carrier 5 and a sixth carrier (carrier 6).

In a second scenario (Scenario 2), Band A is a SUL band or a non-SUL band, Band B is a non-SUL band, and Band C is a non-SUL band. That is Band C is similar as Band B. In a first example of Scenario 2, Band A includes carrier 1, Band B includes carrier 2, Band C includes carriers 3 and 4, and band D includes carrier 5. In a second example of Scenario 2, Band A includes carrier 1, Band B includes carrier 2, Band C includes carriers 3 and 4, and band D includes carriers 5 and 6. In a third example of Scenario 2, Band A includes carrier 1, Band B includes carriers 2 and 3, Band C includes carriers 4 and 5, and band D includes carrier 6. In a fourth example of Scenario 2, Band A includes carrier 1, Band B includes carriers 2 and 3, Band C includes carriers 4 and 5, and band D includes carriers 6 and 7.

Also, for embodiments where the user device 102 performs dynamic Tx carrier switching across the configured bands, at least one of the following options. In a first option, the user device 102 may perform dynamic Tx carrier switching across all the supported UL transmission cases supported by the UE and based on UL scheduling, i.e., via UL grant and/or RRC configuration for UL transmission. In a second option, the network device 104 may indicate two bands out of the configured bands (3 or 4 bands) via DCI or medium access control (MAC) control element (CE). In a third option, the user device 102 may select one anchor Band Among the configured bands (3 or 4 bands), and may perform dynamic Tx carrier switching only from the anchor band to a non-anchor Band And/or from a non-anchor band to the anchor band.

Table 12 shows an example set of ten UL transmit cases for four bands with antenna port number mapping. The second column in Table 12 indicates the antenna port numbers for when the user device 102 does not support simultaneous transmission across multiple carriers, and the third column indicates the antenna port numbers for when the user device 102 supports simultaneous transmission across up to two carriers.

TABLE 12
Example UL Transmit Cases for 4 bands with antenna port number mapping, where
the UE does not support simultaneous transmission across multiple carriers
and does support simultaneous transmission across up to two carriers

| | | Number of antenna ports | Number of antenna ports |
|---|---|---|---|
| | | in Band A, B, C and D | in Band A, B, C and D |
| | Number of Tx | (no simultaneous | (simultaneous |
| | chains in Band | transmission across | transmission across |
| | A, B, C and D | multiple carriers) | up to 2 carriers) |
| Case 1 | 1T + 1T + 0T + 0T | n/a | 1P + 0P + 0P + 0P, |
| | | | 1P + 1P + 0P + 0P, |
| | | | 0P + 1P + 0P + 0P |
| Case 2 | 0T + 2T + 0T + 0T | 0P + 2P + 0P + 0P, | 0P + 2P + 0P + 0P, |
| | | 0P + 1P + 0P + 0P | 0P + 1P + 0P + 0P |
| Case 3 | 2T + 0T + 0T + 0T | 2P + 0P + 0P + 0P, | 2P + 0P + 0P + 0P, |
| | | 1P + 0P + 0P + 0P | 1P + 0P + 0P + 0P |
| Case 4 | 1T + 0T + 1T + 0T | n/a | 1P + 0P + 0P + 0P, |
| | | | 1P + 0P + 1P + 0P, |
| | | | 0P + 0P + 1P + 0P |
| Case 5 | 1T + 0T + 0T + 1T | n/a | 1P + 0P + 0P + 0P, |
| | | | 1P + 0P + 0P + 1P, |
| | | | 0P + 0P + 0P + 1P |
| Case 6 | 0T + 1T + 1T + 0T | n/a | 0P + 1P + 0P + 0P, |
| | | | 0P + 1P + 1P + 0P, |
| | | | 0P + 0P + 1P + 0P |
| Case 7 | 0T + 1T + 0T + 1T | n/a | 0P + 1P + 0P + 0P, |
| | | | 0P + 1P + 0P + 1P, |
| | | | 0P + 0P + 0P + 1P |
| Case 8 | 0T + 0T + 1T + 1T | n/a | 0P + 0P + 1P + 0P, |
| | | | 0P + 0P + 1P + 1P, |
| | | | 0P + 0P + 0P + 1P |
| Case 9 | 0T + 0T + 2T + 0T | 0P + 0P + 2P + 0P, | 0P + 0P + 2P + 0P, |
| | | 0P + 0P + 1P + 0P | 0P + 0P + 1P + 0P |
| Case 10 | 0T + 0T + 0T + 2T | 0P + 0P + 0P + 2P, | 0P + 0P + 0P + 2P, |
| | | 0P + 0P + 0P + 1P | 0P + 0P + 0P + 1P |

For embodiments where the user device 102 supports all UL transmit cases (e.g., all ten UL transmit cases in Table 12) in accordance with the first option above, the user device 102 may switch between any two UL transmit cases without any additional restrictions. For example, suppose a current transmit state of the user device 102 is to transmit on two carriers on two bands using one transmitter to transmit on each band, and the user device 102 is to switch two different carriers on two different bands but still using one transmitter to transmit on each band. For example, the user device 102 may switch from Case 1 to Case 8. Corresponding to Cases 1 and 8 in Table 12, the user device 102 may transmit a first transmission on carrier 1 in cell 1 and on carrier 2 in cell 2 (Case 1), and then switch and transmit a second transmission on carrier 3 in cell 3 and carrier 4 in cell 4 (Case 8). Correspondingly, FIG. 3 shows a one-to-one relationship between four bands, four carriers, and four cells.

Also, in various embodiments, where a user device 102 performs UL Tx switching, including 1Tx-2Tx switching or 2Tx-2Tx switching, that involves only two bands or carriers, and in turn only one band pair, the user device 102 and/or the network device 104 may determine a switching gap that is equal to a switching period of the band pair. For example, suppose a 1Tx-2Tx UL Tx switching that includes switching from 1Tx on a first band/carrier A and 1Tx on a second band/carrier B to 2Tx on the second band/carrier B. For such an example, the band pair is first band A and second band B, and the switching gap is equal to the switching period of the band pair A&B. As another example, suppose a 2Tx-2Tx UL Tx switching that includes switching from 2Tx on the first band/carrier A to 2Tx on the second band/carrier B. For such an example, the band pair includes the first and second bands A and B, and the switching gap is equal to the switching period of the band pair A&B.

In addition or alternatively, in some embodiments, where a user device 102 performs UL Tx switching that involves three or more bands, the user device 102 may report the switching gap per band pair. For example, suppose the user device 102 performs 1Tx-2Tx UL switching that includes switching from 1Tx on the first band/carrier A and 1Tx on the second band/carrier B to 2Tx on a third band/carrier C. A switching gap for the UL Tx switching may be determined by reporting switching periods per band pair, such as the switching period for band pair A&C and/or the switching period for band pair B&C.

Also, in general, a user device 102 may omit an uplink transmission, or refrain from performing an uplink transmission, during a switching gap. In particular embodiments, the user device 102 may omit the uplink transmission during a switching gap, provided that certain one or more conditions are met and the user device 102 is configured with uplinkTxSwitching. Also, a switching gap N_{Tx1-Tx2} may be indicated by UE capability uplinkTxSwitchingPeriod2T2T if uplinkTxSwitching-2T-Mode is configured, and uplinkTxSwitchingPeriod otherwise.

Additionally, in some implementations, for a user device 102 configured in the switchedUL mode (e.g., with uplinkTxSwitchingOption set to ‘switchedUL’), when the user device 102 is to transmit a 1-port transmission on one uplink carrier on one band, and if the preceding uplink transmission was a 1-port transmission on another uplink carrier on another band, then the user device 102 may not be expected to transmit for the duration of switching gap N_{Tx1-Tx2} on any of the carriers. In other cases, the user device 102 may transmit uplink transmissions normally, i.e., without interruptions.

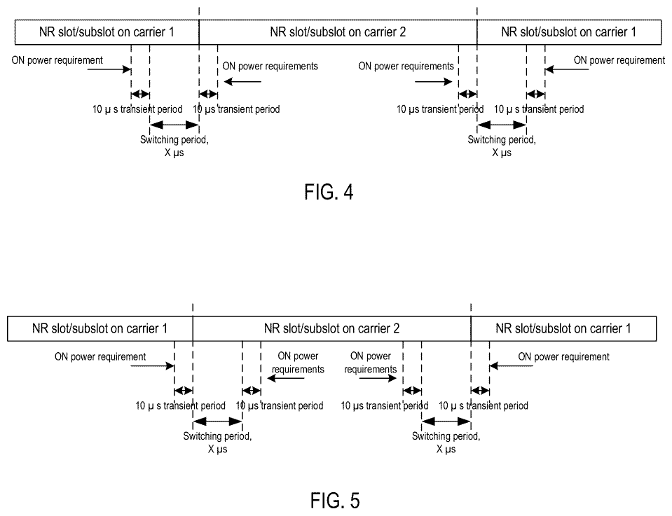

FIG. 4 is a time mask for switching between an UL carrier 1 and an UL carrier 2, where the switching period is located in carrier 1. FIG. 5 is a time mask for switching between UL carrier 1 and UL carrier 2, where the switching period is located in carrier 2. Correspondingly, the switching periods are located in either NR carrier 1 or carrier 2, as indicated by RRC signaling uplinkTxSwitchingPeriodLocation, and the length of uplink switching period X is less than the value indicated by UE capability uplinkTxSwitchingPeriod.

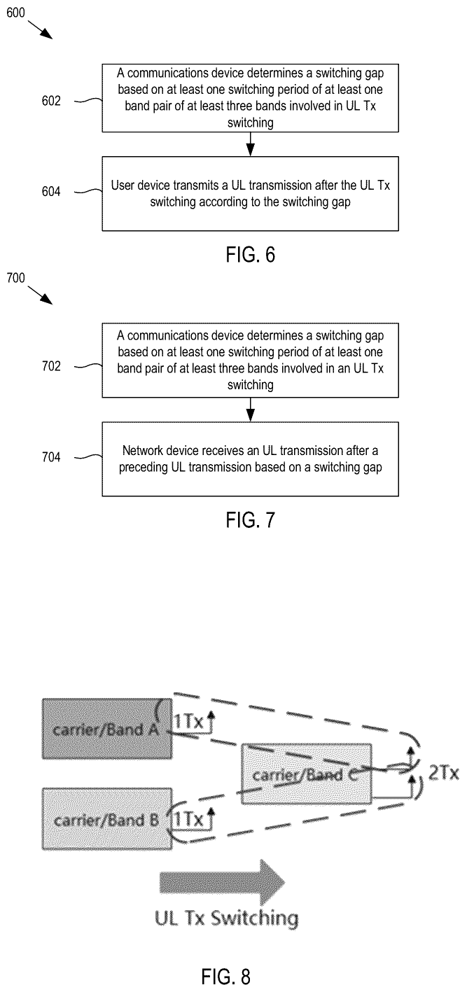

FIG. 6 is a flow chart of an example method 600 for wireless communication related to switching gaps. At block 602, a communications device may determine a switching gap based on at least one switching period of at least one band pair of at least three bands involved in an uplink (UL) transmitter (Tx) switching. In some embodiments, the communications device is or includes the user device 102. In some other embodiments, the communications device is or includes the network device 104. At block 604, the user device 102 may transmit an UL transmission after the UL Tx switching according to the switching gap.

FIG. 7 is a flow chart of another example method 700 for wireless communication related to switching gaps. At block 702, a communications device may determine a switching gap based on at least one switching period of at least one band pair of at least three bands involved in an uplink (UL) transmitter (Tx) switching. In some embodiments, the communications device is or includes the user device 102. In some other embodiments, the communications device is or includes the network device 104. At block 704, the network device 104 may receive a UL transmission after a preceding UL transmission based on switching gap.

In some embodiments of the method 600 and/or the method 700, the communication device is the user device or the network device.

In addition or alternatively, in some embodiments of the method 600 and/or the method 700, the at least one band pair includes only one band pair, and the UL Tx switching includes at least one of: only one transmitter switches from a first band to a second band of the only one band pair; one transmitter on one band that is not part of the only one band pair does not switch to a different band; or a first transmitter switches from the first band to the second band of the only one band pair, and a second transmitter stays on a third band not part of the only one band pair. In some of these embodiments, the switching gap is equal to the switching period of the only one band pair. In addition or alternatively, the UL Tx switching comprises at least one of: switching from one port on the first band and one port on the third band to one port on the second band and one port on the third band; or switching from one port on the first band and one port on the third band to one port on the second band.

In addition or alternatively, in some embodiments of the method 600 and/or the method 700, the at least one band pair includes a plurality of band pairs, the at least one switching period includes a plurality of switching periods of the plurality of band pairs, and each band pair of the plurality of band pairs includes two bands of the at least three bands between which a transmitter switches during the UL Tx switching. In some of these embodiments, the switching gap is based on at least one of a maximum switching period or a sum of the plurality of switching periods. In addition or alternatively, the UL Tx switching includes at least one of: switching a first transmitter from a first band to a third band and switching a second transmitter from a second band to the third band; switching a first transmitter from a third band to a first band and switching a second transmitter from the third band to a second band; switching a first transmitter from a first band to a third band and switching a second transmitter from a second band to a fourth band; or switching a first transmitter from a third band to a first band and switching a second transmitter from a fourth band to a second band. In some of these embodiments, a first band pair of the plurality of band pairs includes the first and third bands and a second band pair of the plurality of band pairs includes the second and third bands, or a first band pair of the plurality of band pairs includes the first and third bands and a second band pair of the plurality of band pairs includes the second and fourth bands. In addition or alternatively, in some of these embodiments, switching from the second band to the third band is not allowed, and a band pair of the plurality of band pairs includes the first and second bands.

In addition or alternatively, in some embodiments, the UL Tx switching includes at least one of: switching from one port on the first band and one port on the second band to two ports on the third band; switching from two ports on the third band to one port on the first band and one port on the second band; switching from one port on the first band and one port on the second band to one port on the third band and one port on the fourth band; or switching from one port on the third band and one port on the fourth band to one port on the first band and one port on the second band.

In addition or alternatively, in some embodiments, preparation procedure time is increased in response to at least one: the UL Tx switching involves at least one band that is not part of a band pair reported by the user device; the UL Tx switching involves at least three bands, and at least one of the at least three bands before or after the UL Tx switching is an anchor band; or a report of a band combination includes that more preparation procedure time is needed. In some of these embodiments, the report of the band combination that includes that more preparation procedure time is needed further comprises more preparation procedure time is needed for all or at least some of a plurality of switching cases involving at least three bands available to the user device to perform the UL Tx switching.

In addition or alternatively, at least some switching cases within at least three bands comprises at least one of: switching from one port on a first band and one port on a second band to two ports on a third band; switching from two ports on the third band to one port on the first band and one port on the second band; switching from one port on the first band and one port on the second band and one port on the third band and one port on the fourth band; or switching from one port on the third band and one port on the fourth band to one port on the first band and one port on the second band.

Further details of various embodiments or aspects, including those for the method 600 and/or the method 700, are now described.

In further detail, in some embodiments, including those where dynamic transmitter carrier switching can be performed across supported transmit cases by the user device 102 based on UL scheduling (i.e., via dynamic grant and/or RRC configuration for UL transmission), and/or UL Tx switching across up to 3 or 4 bands and/or up to 2Tx simultaneous transmission for a user device 102, a user device 102 may perform UL Tx switching involving three bands A, B, C using six example transmit cases (e.g., switch to/from two of the six transmit cases) listed in Table 13 below.

TABLE 13
Example Transmit Cases for UL Tx Switching
involving up to 2Tx and three bands

| Transmit | Number of Tx Chains |
|---|---|
| Cases | (Band A + Band B + Band C) |
| Case 1-1 | 1T + 1T + 0T |
| Case 1-2 | 0T + 1T + 1T |
| Case 1-3 | 1T + 0T + 1T |
| Case 2-1 | 2T + 0T + 0T |
| Case 2-2 | 0T + 2T + 0T |
| Case 2-3 | 0T + 0T + 2T |

Similar possible switching cases for UL Tx switching with 4 UL bands is in Table 12.

In some embodiments, when a user device 102 operates in the switchedUL mode, the user device 102 may perform an uplink transmission on one band before or after switching within bands of a band combination. For example, suppose the band combination includes the three bands A, B, and C. Also, the user device 102 may report a switching period for each band pair A&B, B&C, and A&C, which may have the same or different values as each other. Correspondingly, one band for an UL transmission and another band for the preceding transmission may form a band pair. A user device 102 may determine a switching gap based on the switching period of the band pair. For example, suppose the preceding UL transmission is 1P or 2P on carrier/band A, and then after UL Tx switching, the UL transmission is 1P or 2P on carrier/band B. In turn, the switching period of band pair A&B is used to determine the switching gap. As a result, the switching gap is equal to the switching period of the band pair for SUL/CA option 1. The switching gap for UL Tx switching involving four bands may be similarly determined.

Additionally, in some embodiments, when a user device 102 operates in the dualUL mode (e.g., the transmission switching option parameter, i.e. uplinkTxSwitchingOption, is set to ‘dualUL’), the user device 102 may perform the uplink transmission on one or two bands before or after switching within the band combination (e.g., a band combination including bands A, B, and C). The user device 102 may report the switching period for each band pair A&B, B&C, and A&C, which may have the same or different values as each other. In case there are three bands involved in the UL Tx switching, then the switching gap of the 3 bands involved switching can be determined as follows (Note, the switching gap where the UL Tx switching involves four bands may be similarly determined).

Suppose UL Tx switching involving three bands (bands A, B, and C) with both of the two transmitters being switched. For example, suppose a preceding UL transmission includes 1P on carrier/band A and 1P on carrier/band B. Then, after the UL Tx switching, the UL transmission includes 2P on carrier/band C. This is shown in FIG. 8. In this example, one transmitter (1T) (or one antenna) is switched within a band pair A+C and another transmitter (1T) is switched within band pair B+C. The UL Tx switching for each 1T may be performed over a switching period, which may be determined by per band pair. In addition, the switching gap N_{Tx1-Tx2} for the three bands involved in the UL Tx switching may be determined by a function of the switching period of two or more of the band pairs used for UL Tx switching, examples of which are provided in Table 14 below. Note, as used herein, the switching period per band pair can be applied for both 1T and/or 2T switched within the band pair.

TABLE 14
Swiching gap functions for UL Tx switching involving three bands

| Carrier/band | | the uplink switching | |
|---|---|---|---|
| A + B → C | Switching period | gap N_{Tx1-Tx2} | a period location |
| First | Value 1 for 1T | Alt.1 max{value1, value2}; | Value 1 on band A or C |
| switching | switched in band | Alt.1-1 max{value1, value2, | within band pair A&C; |
| case: | pair A&C; | value 3}; | Value 2 on band B or C |
| 1P + 1P→2P | Value 2 for 1T | Alt.2 sum {value1, value2}; | within band pair B&C; |
| | switched in band | | |
| | pair B&C; | | |
| | Value 3 of band pair | | |
| | A&B; | | |
| Second | Value 1 for 1T | Alt.3 max {value1, value1 + | Value 1 on band A or C |
| switching | switched in band | value3} = value1 + value3; | within band pair A&C; |
| case: | pair A&C; | Alt.4 | Value 3 on band A or B |
| 1P + 1P→2P | Value 3 for 1T | Max(value1,value3) + value1; | within band pair A&B; |
| With | switched in band | (optionally, after switching, | |
| condition that | pair A&B | band pair is A&C) | |
| band pair | | | |
| B&C is not | | | |
| reported, or | | | |
| band A is | | | |
| anchor band, | | | |
| directly B→C | | | |
| is not | | | |
| allowed. | | | |

In Table 14, in the first switching case, the UL Tx switching involves switching between (e.g., to or from) a first transmitter (1Tx) transmitting on one port (1P) on a first carrier/band A and a second transmitter (1Tx) transmitting on one port (1P) on a second carrier/band B and both the first and second transmitters (2Tx) transmitting on two ports on a third carrier/band C. The UL Tx switching may include two band pairs, including A&C and B&C. The first band pair A&C may correspond to the first transmitter switching between the first and third bands A and C, and the second band pair B&C may correspond to the second transmitter switching between the second and third bands B and C. A first switching period for the first band pair A&C may have a first value (Value 1), and a second switching period for the second band pair B&C may have a second value (Value 2). Also, the first switching period may have the first value (Value 1) on band A or band C within the band pair A&C, that is the switching period location can be configured on one carrier/band. In addition or alternatively, the second switching period may have the second value (Value 2) on band B or band C within the band pair B&C. In some embodiments (denoted as Alt. 1 in Table 14), the user device 102 and/or the network device 104 may determine the switching gap N_{Tx1-Tx2} for the UL Tx switching to be, or based on, a maximum of the first switching period (Value 1) and the second switching period (Value 2). In other embodiments (denoted as Alt. 2 in Table 14), the user device 102 and/or the network device 104 may determine the switching gap N_{Tx1-Tx2} for the UL Tx switching to be, or based on, the sum of the first switching period (Value 1) and the second switching period (Value 2). In other embodiments (denoted as Alt. 1-1 in Table 14), the user device 102 and/or the network device 104 may determine the switching gap N_{Tx1-Tx2} for the UL Tx switching to be, or based on, the maximum of the first switching period (Value 1), the second switching period (Value 2) and the third switching period (Value 3). That is, the switching period of all available/reported band pairs comprising the bands involved for the UL Tx switching are used to determine the switching gap. In other embodiments, the user device 102 and/or the network device 104 may determine the switching gap N_{Tx1-Tx2} for the UL Tx switching to be, or based on, the Alt.1 if UE is able to switch the 1st Tx and 2nd Tx independently, Alt.2 otherwise. Optionally, a UE capability is used to indicate whether the UE is able to switch the 1st Tx and 2nd Tx independently.

In Table 14, the UL Tx switching with the second switching case is the same as the UL Tx switching in the first row, except that the UL Tx switching in the second row has the condition that the band pair B&C is not reported or band A is an anchor band, or correspondingly, switching between bands B and C is not allowed. Correspondingly, the switching periods used to determine the switching gap N_{Tx1-Tx2} may include a first switching period (Value 1) for one transmitter to switch between bands A and C (or band pair A&C), and a third switching period (Value 3) for one transmitter to switch between bands A and B (or band pair A&B). Also, the first switching period may have the first value (Value 1) on band A or band C within band pair A&C, and/or the third switching period may have the third value (Value 3) on band A or band B within band pair A&B. In some embodiments (denoted as Alt. 3), the user device 102 and/or the network device 104 may determine the switching gap N_{Tx1-Tx2} to be, or based on, the sum of the first switching period and the third switching period. In other embodiments (denoted as Alt. 4), the user device 102 and/or the network device 104 may determine the switching gap N_{Tx1-Tx2} to be, or based on, the sum of the maximum the first and third switching periods, and the first switching period.

In addition or alternatively, in some embodiments, the user device 102 and/or the network device 104 may not know the band pair after performing a UL Tx switching instance. For example, the user device 102 and/or the network device 104 may not know whether the band pair after UL Tx switching is band pair A&C or band pair B&C.

In addition or alternatively, a switching period location may be reused for a band pair. That is, for each 1T (1 antenna) switched within a band pair, the switching period location can be determined in any of various ways. For example, the carrier/band of a switching period location may be configured by RRC signaling.

In addition or alternatively, in event that a switching period location on a carrier in one band pair and a switching period location of a carrier in another band pair are both the carrier(s) before or after the UL Tx switching (e.g., carrier 1 or carrier 2), the user device 102 and/or the network device 104 may determine the switching gap by the maximum value of the switching periods of the two band pairs for each Tx switching. For example, suppose the preceding UL transmission is 1P on carrier/band A and 1P on carrier/band B. In addition, suppose after the UL Tx switching, the UL transmission is 2P on carrier/band C. This can be regarded as 1T (1 antenna) switched within band pair A&C and the other 1T switched within band pair B&C, and the switching period location of the carrier of band A is configured as TRUE and carrier 1, which means that the switching period will be located on the carrier of band A as the carrier before the switching. In addition, the switching period location of the carrier of band B configured as TRUE and carrier 1 means that the switching period will be located on the carrier of band B as the carrier before the switching. The switching period location of the carrier of band C configured as FALSE and carrier 2 means that the switching period will not be located on the carrier of band C as the carrier after the switching. Correspondingly, the switching gap N_{Tx1-Tx2} for the UL Tx switching involving three bands may be determined by Alt.1, that is by the maximum value of the switching periods of the band pairs for each Tx switching.

In addition or alternatively, the switching gap N_{Tx1-Tx2} may be determined, or considered in the calculation of switching gap, based on the direction or the switching. For example, the switching period may be reported per band pair with a specific switching direction.

In other embodiments, a user device 102 may perform UL Tx switching involving three bands, where only one transmitter (1Tx) switches between bands. For example, in the example in Table 15, the preceding UL transmission is 1P on carrier/band A and 1P on carrier/band B. Then, after UL Tx switching, the UL transmission is 1P on carrier/band C. Correspondingly, the switching gap N_{Tx1-Tx2} can be determined by 1T switched within band pair B&C or band pair A&C. For example, the switching gap N_{Tx1-Tx2} may be equal to the switching period of one band pair. In some of these embodiments, an ambiguity issue may be present, where the user device 102 and/or the network device 104 may not know whether a given UL Tx switching involves switching one transmitter (1Tx) or switching two transmitters (2Tx), such as because the state of the Tx chains after switching is not unique to a particular transmit case. For such embodiments, the user device 102 and/or the network device 104 may determine a band pair according to one or more of various ways. In one way, the user device 102 and/or the network device 104 may use RRC signaling to indicate one state of Tx chains. In another way, the user device 102 and/or the network device 104 may assume 2Tx, and in turn determine the switching gap according to any of Alt. 1, Alt. 2, Alt. 3, or Alt. 4 indicated above in Table 14. In other way, the user device 102 and/or the network device 104 may assume 1Tx on band pair A&C, and in response, use the second switching period (Value 2) due to 1Tx switched within band pair B&C. In another way, the user device 102 and/or the network device 104 may assume 1Tx on band pair B&C, and in response, use the first switching period (Value 1) due to 1Tx switched within band pair A&C. In another way, the user device 102 and/or the network device 104 may assume 1Tx on two bands (e.g., 1Tx is switched within band pair A&C or band pair B&C), and in response, use Alt. 1, Alt. 2, Alt. 3, or Alt. 4 in Table 14 to determine the switching gap.

TABLE 15
Example switching gap determination in event of an ambiguity issue

| Carrier/band | | the uplink switching | |
|---|---|---|---|
| A + B → C | Switching period | gap N_{Tx1-Tx2} | a period location |
| 1P + 1P→1P | Value 1 for 1T | Alt.5 Combined with solution | Value 1 on band A or C |
| | switched in band | of ambiguity issue, one of | within band pair A&C; |
| | pair A&C; or | {value1, value2} is applied. | or |
| | Value 2 for 1T | or Alt.1/2/3/4 in Table 3. | Value 2 on band B or C |
| | switched in band | | within band pair B&C; |
| | pair B&C | | |

In other embodiments of UL Tx switching involving three bands, 1T on one band may not change. Example switching gap determination for such embodiments is shown in Table 16. In Table 16, the preceding UL transmission includes 1P on carrier/band A and 1P on carrier/band B. Then, after UL Tx switching, the UL transmission includes 1P on carrier/band A and 1P on carrier/band C. The user device 102 and/or the network device 104 may determine the switching gap by 1T switched within band pair B&C. For example, the switching gap may be equal to the switching period of the band pair B&C.

TABLE 16
Example switching gap determination when one transmitter does not change

| Carrier/band | | the uplink switching | |
|---|---|---|---|
| A + B → A + C | Switching period | gap N_{Tx1-Tx2} | a period location |
| 1P + 1P→1P + 1P | Value 2 for 1T | Alt.6 value2; | Value 2 on band B or C |
| | switched in band | | within band pair B&C; |
| | pair B&C; | | |

In other embodiments, UL Tx switching may involve four bands, as previously described. For some of these embodiments, shown in Table 17, the user device 102 and/or the network device 104 may determine the switching gap based on 1T switched within band pair A&C or band pair B&C, and the other 1T switched within band pair B&D or band pair A&D. In other embodiments, the switching gap N_{Tx1-Tx2} for the UL Tx switching is, or is based on, the maximum of the first switching period (Value 1), the second switching period (Value 2), the third switching period (Value 3) and the fourth switching period (Value 4). That is, the switching period of all available/reported band pairs comprising the bands involved for the UL Tx switching is used to determine the switching gap.

TABLE 17
Example switching gap determination for UL Tx switching involving four bands

| Carrier/band | | the uplink switching | |
|---|---|---|---|
| A + B → C + D | Switching period | gap N_{Tx1-Tx2} | a period location |
| Switching | Value 1 for 1T | Alt.1 | {Value 1 on band A or C |
| case: | switched in band pair | max{value1, value2}, | within band pair A&C; |
| 1P + 1P→1P + 1P | A&C; | or | Value 2 on band B or C within |
| | Value 2 for 1T | max{value3, value4}, | band pair B&C} or |
| | switched in band pair | or | {Value 3 on band B or C |
| | B&D; | max{value1, 2, 3, 4(if | within band pair B&C; |
| | Value 3 for 1T | any)} | Value 4 on band B or C within |
| | switched in band pair | Alt.2 sum{value1, | band pair A&D} |
| | B&C; | value2} or | [Optionally need additional |
| | Value 4 for 1T | sum{value3, value4} | rules or RRC signalling to |
| | switched in band pair | | determine one of above] |
| | A&D; | | |

In addition or alternatively, in event that a switching period location on a carrier in one band pair and a switching period location of a carrier in another band pair are not both the carrier(s) before or after the UL Tx switching (e.g., carrier 1 or carrier 2), the user device 102 and/or the network device 104 may determine the switching gap by the sum values of the switching periods of the two band pairs for each Tx switching. For example, suppose the preceding UL transmission is 1P on carrier/band A and 1P on carrier/band B. In addition, suppose after the UL Tx switching, the UL transmission is 1P on carrier/band C and 1P on carrier/band D. This can be regarded as 1T (1 antenna) switched within band pair A&C and the other 1T switched within band pair B&D, and the switching period location of the carrier of band A is configured as TRUE and carrier 1, which means that the switching period will be located on the carrier of band A as the carrier before the switching. In addition, the switching period location of the carrier of band B configured as FALSE and carrier 1 means that the switching period will not be located on the carrier of band B as the carrier before the switching. The switching period location of the carrier of band C configured as FALSE and carrier 2 means that the switching period will not be located on the carrier of band C as the carrier after the switching. The switching period location of the carrier of band D configured as TRUE and carrier 2 means that the switching period will be located on the carrier of band C as the carrier after the switching. Correspondingly, the switching gap N_{Tx1-Tx2} for the UL Tx switching involving four bands may be determined by Alt.2, that is by the sum values of the switching periods of the band pairs for each Tx switching.

In sum, for embodiments where only two bands and/or one band pair are involved in UL Tx switching, the user device 102 and/or the network device 104 may use the switching period of the one band pair to determine the uplink switching gap N_{Tx1-Tx2}. Also, for embodiments where the UL Tx switching involves three or more bands (e.g., three or four bands), the switching periods of one or more band pairs are used to determine the uplink switching gap N_{Tx1-Tx2}. A band pair is used for two bands that one transmitter (1T) switched from/to within the two bands, and the corresponding switching period is used to determine the switching gap. In particular embodiments, one or two band pairs are used to determine the switching gap for UL Tx switching involving three bands. In addition or alternatively, two or more band pairs are used to determine the switching gap for UL Tx switching involving four bands. As explained, and as indicated in Tables 14-17, the user device 102 and/or the network device 104 may apply one or more function or algorithms, such a maximum value function and/or a summation function, on two or more switching period values to determine or derive the switching gap. Also, as mentioned, the function may include, or the switching gap may otherwise be determined, based on a switching direction associated with one or more of the band pairs. For example, each band pair including a first band and a second band may have up to two switching directions, including a first switching direction from the first band to the second band, and a second switching direction from the second band to the first band.

Also, for at least some embodiments, a user device 102 may omit uplink transmission during the uplink switching gap N_{Tx1-Tx2} if the user device 102 is configured with uplinkTxSwitching. The switching gap N_{Tx1-Tx2} is indicated by UE capability uplinkTxSwitchingPeriod2T2T if uplinkTxSwitching-2T-Mode is configured, and uplinkTxSwitchingPeriod otherwise for UL Tx switching involving two bands, or 1Tx on one band does not change for UL Tx switching involving more than two bands. The switching gap N_{Tx1-Tx2} is the maximum value of the two band pairs with each indicated by UE capability uplinkTxSwitchingPeriod2T2T if uplinkTxSwitching-2T-Mode is configured, and uplinkTxSwitchingPeriod otherwise for 1Tx switched within the band pair for UL Tx switching involving three or four bands.

Also, for at least some embodiments, for a user device 102 indicating a capability for uplink switching with BandCombination-UplinkTxSwitch or uplinkTxSwitchingPeriod2T2T for a band combination, and if it is for that band combination configured with uplink carrier aggregation: when the user device 102 is to transmit a 2-port transmission on one uplink carrier on one band and if the preceding uplink transmission is a 1-port transmission on a second uplink carrier on a second band and a one-port transmission on a third uplink carrier on a third band, then the user device 102 is not expected to transmit for the duration of the switching gap N_{Tx1-Tx2} on any of the carriers.

One benefit is that the switching gap may be determined by a function of the switching period of each band pair used for 1T (or 1 antenna) switched within a band pair. In turn, additional switching periods between band pairs may be avoided for UL Tx switching involving greater than three bands. In addition, the current switching period per band pair may be reused to determine the switching gap.

Additionally, in some embodiments, including those where dynamic Tx carrier switching is performed across all the supported switching cases by a user device 102 and based on UL scheduling, i.e., via dynamic grant and/or RRC configuration for UL transmission, the user device 102 is allowed more preparation procedure time (or interruption time). For at least some of these embodiments, more preparation procedure time is allowed only for some specific switching cases/patterns. Also, as used herein, preparation procedure time may include a time used to prepare for transmitting a PUSCH, a PUCCH, or a sounding reference signal (SRS).

For example, in some embodiments, the memory (e.g., the UL capacity of read only memory (ROM) or random access memory (RAM), or baseband procedure capacity, or other capacity, including memory used to store data/bits of carriers and/or bands) of the user device 102 may depend on a number of bands. That is, memory is used for each band, and more preparation procedure time may be needed or used for switching cases that involves at least three bands. UL Tx switching involving three bands may include: switching from band A and band B to band C, or from band A and band B to band A and band C. UL Tx switching involving four bands may include: switching from band A and band B to band C and band D. In addition, more preparation procedure time may be needed or used for UL Tx switching involving two bands if the two bands do not belong to a band pair reported by the user device 102. That is, in case only two band pairs are reported by the user device 102, e.g., band pair A&B and band pair C&D, then more preparation procedure time may be needed or used for UL Tx switching involving two bands, e.g., switching from band A to band C.

For another example, the memory of the user device 102 may depend on each switching band pair. That is, the memory is used or needed for each switching band pair, which may be combined with specific switching direction. For at least some embodiments, an anchor band is introduced and more preparation procedure time may be used or needed for: (1) switching between non-anchor bands with the condition that an anchor band is included in the band pair; or (2) an UL transmission is performed only on the non-anchor bands after the UL Tx switching if the Tx chain state changed. Further, more preparation procedure time is also needed for switching cases including two bands if the two bands do not belong to a band pair reported by the user device 102. That is, potential switching cases/patterns include that in event there are two anchor bands, where the same anchor band is involved both before and after the UL Tx switching, and the UI Tx switching involves at least three bands (for example, switching from band A and band B to band A and band C, wherein band A and band D are anchor bands), more preparation procedure time is used or needed.

As another example, the memory of the user device 102 may depend on a threshold. That is, the memory may be used or needed for one or more bands within a threshold, rather than being dependent on the number of bands. In this case, the user device 102 may report whether more time (e.g., more preparation procedure time or interruption time) is needed for all switching cases/patterns, or just for only some of the switching cases/patterns, such as those switching cases/patterns that use three or four bands when performing UL Tx switching. In some of these embodiments, the user device 102 may report per band combination. For example, if the memory for a band combination A&B&C is within a threshold, then no more time is reported for this band combination. And the switching gap can be determined by the methods in other embodiments. In addition, if the memory for the band combination C&D&E is larger than a threshold, then more time is reported for this band combination. This may be reflected on T_{switch} for T_proc2, which is the minimum time for PUSCH preparation. Also, in some embodiments, more preparation procedure time may be independent of the switching gap, may include the switching gap or the switching period, or may be a function of multiple switching periods of each used band pair. That is, more preparation procedure time is not dependent on specific switching cases/patterns, but rather is dependent on whether the memory of three or four bands is larger than a threshold.

In some embodiments, regardless of whether the memory of the user device 102 depends on the number of bands, each switching band pair or a threshold, the value(s) of preparation procedure time or interruption time can be reported and/or indicated for the band combination or the specific switching cases/patterns within the band combination.

In addition or alternatively, regardless of whether the memory of the user device 102 depends on the number of bands, each switching band pair or a threshold, more preparation procedure time or interruption time may be independent of the switching gap or include the switching gap or the switching period, or may be a function of multiple switching periods of each used band pair.

In addition or alternatively, the preparation procedure time or interruption time can be one or more OFDM symbols, or one or more candidates value, such as 210 us or 500 us, as non-limiting examples.

In sum, more preparation procedure time may be needed or used for potential switching cases/patterns (e.g., memory of the user device 102 depends on the number of bands) where UL Tx switching involving two bands is performed, and the two bands are not part of the band pair that is reported. In addition or alternatively, more preparation procedure time may be used for potential switching cases/patterns (e.g., the memory of the user device 102 depends on each switching band pair) where the UL Tx switching involves three bands and both before and after switching includes an anchor band, where two anchor bands are introduced. In addition or alternatively, more preparation procedure time may be used for all or at least some switching cases/patterns (e.g., the memory of the user device 102 depends on a threshold regardless of the number of bands) if the memory for a band combination (with more than two bands) is larger than a threshold. The report may be per band combination (BC), whether more preparation procedure time is needed for the BC or for potential cases/patterns (e.g., UL Tx switching involving three or four bands) of the BC.

In sum, for some embodiments, including those where the user device 102 operates with CA option 1 or CA option 2, more preparation procedure time (or interruption time) may be used for at least some switching cases/patterns, or are used per band combination via UE reporting for all switching cases/patterns, or for only some transmit switching cases/patterns, such as those where the user device 102 performs UL Tx switching involving three or four bands. One benefit may be that more preparation procedure time reduces the user device complexity when performing UL Tx switching among more than 2 bands.

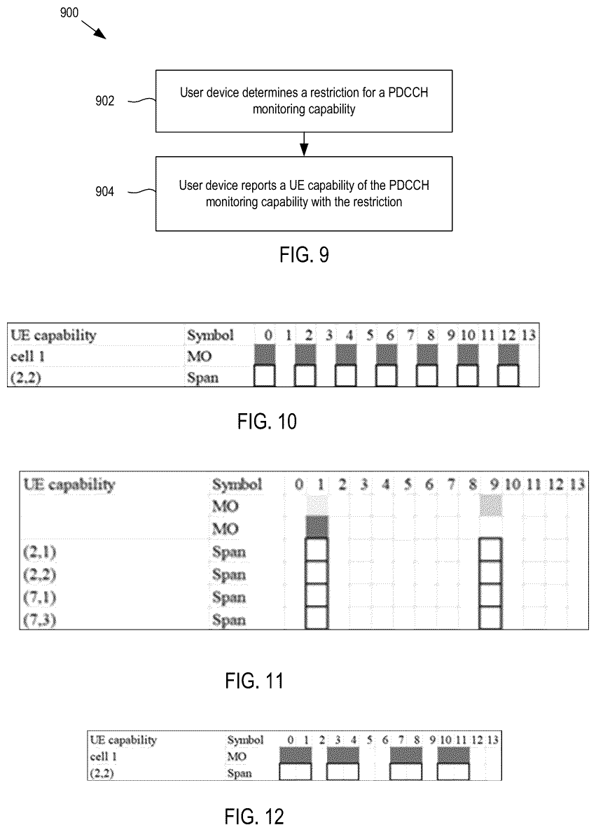

FIG. 9 is a flow chart of an example method 900 for wireless communication. At block 902, a user device 102 determines a restriction for a PDCCH monitoring capability. At block 904, the user device 102 reports a UE capability of the PDCCH monitoring capability with the restriction.

In some embodiments of the method 900, the restriction includes at least one: adjacent PDCCH monitoring occasions are allowed to be configured and the user device will discard partial adjacent PDCCH monitoring occasions; a maximum number of adjacent spans or PDCCH monitoring occasions; a maximum number of spans or PDCCH monitoring occasions within a slot is defined; the same maximum number of DL and UL unicast DCI formats is relaxed from in one span to in two or more adjacent spans; or one or more scaled (M,C) value is introduced, wherein M is a maximum number of monitored physical downlink control channel (PDCCH) candidates per span, and C is a maximum number of non-overlapped control channel elements (CCEs) per span. In addition or alternatively, in some embodiments of the method 900, the restriction is applied for a combination (2,2) at least for when there is one span with a duration equal to 2 orthogonal frequency-division multiplexing (OFDM) symbols.

Further details of aspects or embodiments, including those for method 900, are now described.

In a current ultra-reliable low latency communications (URLLC) procedure, a span is defined as below and used for PDCCH monitoring.

A user device 102 can indicate a capability to monitor PDCCH according to one or more of the combinations (X,Y)=(2,2), (4,3), and (7,3), per sub-carrier spacing (SCS) configuration of u=0 and u=1. A span is a number of consecutive symbols in a slot where the user device 102 is configured to monitor PDCCH. Each PDCCH monitoring occasion is within one span. If a user device 102 monitors PDCCH on a cell according to combination (X,Y), the user device 102 supports PDCCH monitoring occasions in any symbol of a slot with minimum time separation of X symbols between the first symbol of two consecutive spans, including across slots. A span starts at a first symbol where a PDCCH monitoring occasion starts and ends at a last symbol where a PDCCH monitoring occasion ends, where the number of symbols of the span is up to Y.

For the (2,2) pattern, a user device 102 performs PDCCH decoding in every symbol. As a consequence, the control decoding overhead under the (2,2) pattern may be significant for a user device 102. Although PDCCH monitoring on every symbol of a slot is not required under (4,3) and (7,3) patterns, PDCCH processing across up to three consecutive symbols, in particular with timing capability 2 for DL and/or UL, is challenging.

There may be two ways to resolve this issue. In a first way: introduce an additional restriction based on current (X,Y)=(2,2) span, and in some embodiments, also for (X,Y)=(4, 3) and (7, 3) spans. In a second way, introduce a new span (X,Y)=(2,1), and in some embodiments, (X,Y)=(4, 1) and (7, 1) spans.

Based on the first way, how the additional restriction is defined is described below. For the second way, some additional issues may be addressed.

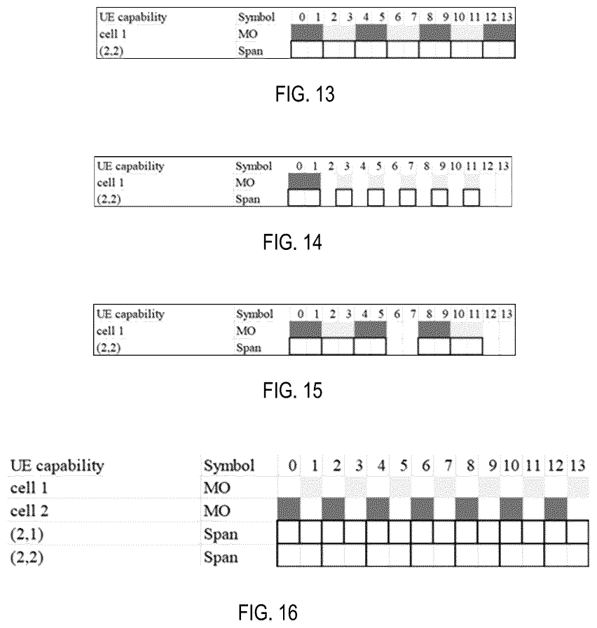

For the first way, in one embodiment, the additional restriction may be defined according to at least one of the following options. In a first option (Option1): limit the control resource set (CORESET) duration equal to one, and/or preclude adjacent PDCCH monitoring occasions. In other embodiments (Alt.1), limit the CORESET duration equal to 1 and preclude adjacent PDCCH monitoring occasions. In some of these embodiments (Alt.1-1), the user device 102 and/or the network device 104 is not allowed to configure and/or discard adjacent PDCCH monitoring occasions (MO). The result is shown in FIG. 10. In some of other of these embodiments (Alt.1-2), the user device 102 and/or the network device 104 may be allowed to configure adjacent MOs and/or discard partial adjacent PDCCH MOs. The gNB may configure adjacent MOs, and the user device 102 may discard partial adjacent MOs. In some other embodiments (Alt.2), still based on two orthogonal frequency-division multiplexing (OFDM) symbols (2OS) MO and preclude adjacent PDCCH monitoring occasions. In some of these embodiments (Alt.2-1), the user device 102 and/or the network device 104 is not allowed to configure and/or discard adjacent PDCCH MOs, an example result of which is shown in FIG. 12. In some other of these embodiments (Alt.2-2), the user device 102 and/or the network device 104 is allowed to configure adjacent MOs and/or discard partial adjacent PDCCH MOs, an example of which is shown in FIG. 13. The gNB may configure adjacent MOs, and the user device 102 may discard partial adjacent MOs, e.g., the MO on symbol #6&7, 12&13. In some other of these embodiments (Alt.2-3), a restriction on the maximum number of adjacent spans and/or spans within a slot, e.g., <7. In some of these embodiments, at least where is one span with duration=2OS, e.g., in case of mixed 1OS span and 2OS span. FIG. 14 shows a restriction on the maximum number of spans within a slot is six. FIG. 15 shows a restriction on the maximum number of adjacent spans within a slot is three (combined with restriction on the maximum number of spans within a slot is five or six.

A second option (Option 2) may relax the maximum number of DL and UL unicast DCI formats in a span. In some embodiments, the maximum number of DL and UL unicast formats in a span may be determined or set according to, for the set of monitoring occasions which are within the same span: processing one unicast DCI scheduling DL and one unicast DCI scheduling UL per scheduled component carrier (CC) across this set of monitoring occasions for frequency division duplex (FDD); processing one unicast DCI scheduling DL and two unicast DCI scheduling UL per scheduled CC across this set of monitoring occasions for time division duplex (TDD); processing two unicast DCI scheduling DL and one unicast DCI scheduling UL per scheduled CC across this set of monitoring occasions for TDD.

In other embodiments, the current “Maximum number of DL and UL unicast DCI formats in a span” may be changed to “Maximum number of DL and UL unicast DCI formats in adjacent two spans”. That is, in case the maximum number of unicast DCI are detected in a span, then the user device 102 may skip the next adjacent span to avoid performing PDCCH decoding in every symbol and low latency requirement can be also achieved.

In a third option (Option 3), one or more scaled (M,C) value may be introduced. That is, for span (2,2), a reduced (M,C) value can be applied for a user device 102 if it reported UE FG x-yyy. For example, using 0.5 as a scaling factor to define the new UE FG x-yyy, then the half value of M may be used to reduce the UE monitoring capability.

Table 18 below provides the maximum number of monitored PDCCH candidates, M_{PDCCH}^{max,(X,Y),μ}, per span for a user device 102 in a DL bandwidth part (BWP) with SCS configuration u for operation with a single serving cell.

TABLE 18
Maximum number M_{PDCCH}^{max,(X,Y),μ} of monitored PDCCH
candidates in a span for combination (X, Y) for a DL BWP
with SCS configuration μ ∈ {0, 1} for a single serving cell

| | Maximum number M_{PDCCH}^{max,(X,Y),μ} of monitored | | |
|---|---|---|---|
| | PDCCH candidates per span for combination | | |
| | (X, Y) and per serving cell | | |
| μ | (2, 2) | (4, 3) | (7, 3) |
| 0 | 14 | 28 | 44 |
| 1 | 12 | 24 | 36 |

Furthermore, the scaled (M,C) value may be only used for M_max, allowing for no impact on M_total in a CA scaling calculation. In addition or alternatively, the scaled (M,C) value may be also used for M_total in CA scaling calculation. That is, the cell number may also be scaled by the scaling factor for the cell configured the scaling factor.

In sum, for the first way, introduce an additional restriction based on current (X,Y)=(2,2) span. In a first implementation (Method 1): preclude adjacent PDCCH monitoring. In some of these implementations (method 1-1), allow the user device 102 and/or the network device 104 to configure adjacent MOs and discard partial adjacent PDCCH MOs. In some other of these implementations (method 1-2), include a restriction on the maximum number of adjacent spans and/or spans within a slot, e.g., <7. In some of these embodiments, at least for the case that there is one span with duration=2OS, e.g., in case of mixed 1OS span and 2OS span. In some other implementations (Method 2), relax the maximum number of DL and UL unicast DCI formats in a span, e.g, in adjacent two spans. In some other implementations (Method 3), introducing one or more scaled (M,C) value.

Also, for method 1, a user device 102 may be always provided a rest time after one or more spans regardless if a URLLC DCI is detected or not. For method 2, a user device 102 can be provided a rest time after one or more spans in case URLLC DCI is detected. For method 3, a user device 102 can be guaranteed not to monitor excessively due to the reduced (M,C).

Also, in some embodiments, based on the second way 2, some additional issues are addressed. One issue is how to select one of multiple combinations (X,Y).

In some embodiments, if a user device 102 indicates a capability to monitor PDCCH according to multiple (X,Y) combinations and a configuration of search space sets to the user device 102 for PDCCH monitoring on a cell results to a separation of every two consecutive PDCCH monitoring spans that is equal to or larger than the value of X for one or more of the multiple combinations (X,Y), the user device 102 monitors PDCCH on the cell according to the combination (X,Y), from the one or more combinations (X,Y), that is associated with the largest maximum number of M_{PDCCH}^{max,(X,Y),μ} and C_{PDCCH}^{max,(X,Y),μ} defined in Table 18 and Table 19. The user device 102 may expect to monitor PDCCH according to the same combination (X,Y) in every slot on the active DL BWP of a cell.

TABLE 19
Maximum number C_{PDCCH}^{max, (X,Y),μ} of non-overlapped
CCEs in a span for combination (X, Y) for a DL BWP with
SCS configuration μ ∈ {0, 1} for a single serving cell

| | Maximum number C_{PDCCH}^{max,(X,Y),μ} of non- | | |
|---|---|---|---|
| | overlapped CCEs per span for combination | | |
| | (X, Y) and per serving cell | | |
| μ | (2, 2) | (4, 3) | (7, 3) |
| 0 | 18 | 36 | 56 |
| 1 | 18 | 36 | 56 |

In addition, if both FG 11-2x (new UE feature with support (X,Y)=(2,1), or (2,1), (4,1), (7,1)) and FG 11-2 (legacy UE feature with support (X,Y)=(2,2), (4,3), (7,3)) are reported, how to select one of combination (X,Y) in case the maximum BD/CCE per span for combination (X,Y)=(2,2) and (2,1) are the same, the maximum BD/CCE per span for combination (X,Y)=(4,3) and (4,1) are same, and/or the maximum BD/CCE per span for combination (X,Y)=(7,3) and (7,1) are same, is determined.

For example, in some embodiments, (2,2), (7,3) in FG 11-2 are reported by a user device 102, and (7,3) may be selected out for PDCCH monitoring by the user device 102. For another example, (2,1), (7,1) in FG 11-2x and (2,2), (7,3) in FG 11-2 are reported by a user device 102, as shown in FIG. 11, and one of (7, 1) and (7, 3) is selected out based on one of following options.

In a first option (Option 1): specification does not change, and/or any one of (X, 1) and (X, 2/3) is allowed. In a second option (Option 2), the specification is changed with an additional condition including a largest Y. In a third option (Option 3), the specification is changed with an additional condition including a smallest Y.

For embodiments where option 2 and/or option 3 are used, then the specification is updated as follows.

If a user device 102 indicates a capability to monitor PDCCH according to multiple (X,Y) combinations and a configuration of search space sets to the user device 102 for PDCCH monitoring on a cell results to a separation of every two consecutive PDCCH monitoring spans that is equal to or larger than the value of X for one or more of the multiple combinations (X,Y), the user device 102 monitors PDCCH on the cell according to the combination (X,Y), from the one or more combinations (X,Y), that is associated with the largest maximum number of M_{PDCCH}^{max,(X,Y),μ} and C_{PDCCH}^{max,(X,Y),μ} defined in Table 18 and Table 19 with largest or smallest value of Y. The user device 102 may expect to monitor PDCCH according to the same combination (X,Y) in every slot on the active DL BWP of a cell.

A second issue is how to determine CA scaling. In some embodiments, if a user device 102 is configured only with N_{cells,r16}^{DL,μ} downlink cells for which the user device 102 is provided monitoringCapabilityConfig=r16monitoringcapability and with associated PDCCH candidates monitored in the active DL BWPs of the scheduling cells using SCS configuration μ, and with N_{cells,r16}^{DL,(X,Y),μ} of the N_{cells,r16}^{DL,μ} downlink cells using combination (X,Y) for PDCCH monitoring, where Σ_{μ=0}¹N_{cells,r16}^{DL,μ}>N_{cells}^{cap-r16}, a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,(X,Y),μ}=└N_{cells}^{cap-r16}·M_{PDCCH}^{max,(X,Y),μ}·N_{cells,r16}^{DL,(X,Y),μ}/Σⱼ₌₀¹N_{cells,r16}^{DL,j}┘ PDCCH candidates or more than C_{PDCCH}^{total,(X,Y),μ}=└N_{cells}^{cap-r16}·C_{PDCCH}^{max,(X,Y),μ}·N_{cells,r16}^{DL,(X,Y),μ}/Σⱼ₌₀¹N_{cells,r16}^{DL,j}┘ non- overlapped CCEs
per set of spans on the active DL BWP(s) of all scheduling cell(s) from the N_{cells,r16}^{DL,(X,Y),μ} downlink cells within every X symbols, if the union of PDCCH monitoring occasions on all scheduling cells from the N_{cells,r16}^{DL,(X,Y),μ} downlink cells results to PDCCH monitoring according to the combination (X,Y) and any pair of spans in the set is within Y symbols, where first X symbols start at a first symbol with a PDCCH monitoring occasion and next X symbols start at a first symbol with a PDCCH monitoring occasion that is not included in the first X symbols
per set of spans across the active DL BWP(s) of all scheduling cells from the N_{cells,r16}^{DL,(X,Y),μ} downlink cells, with at most one span per scheduling cell for each set of spans, otherwise
where N_{cells,r16}^{DL,j} is a number of configured cells with associated PDCCH candidates monitored in the active DL BWPs of the scheduling cells using SCS configuration j. If a UE is configured with downlink cells for which the UE is provided both monitoringCapabilityConfig=r15monitoringcapability and monitoringCapabilityConfig=r16monitoringcapability, N_{cells}^{cap-r16} is replaced by N_{Ncells,r16}^{cap-r16}.

In some embodiments, M_total in URLLC is calculated per (X,Y). For at least some of these embodiments, Option 2 or Option 3 for the first issue is used. Further, Option 2 or Option 3 may have different impact when determining aligned or unaligned spans. For example, suppose a cell 1 and a cell 2 with single-symbol for each MO which are matched any one of (2,1) and (2,2). If option 2 in issue 1 is used, then they are aligned spans. In addition, if Option 3 in issue 1 is used, then they are unaligned spans. As a result, UE complexity is less for Option 2 compared with Option 3 due to PDCCH monitoring for aligned spans is easy for a user device 102 to handle.

Also, in some embodiments, option 1 in issue 1 is used. For such embodiments, CA scaling may be updated as for per (X,Y1/Y2), because the M_{PDCCH}^{max,(X,Y),μ} for (X,Y1/Y2) are the same. Correspondingly, the specification changes may include:
change Y to Yi, i.e. M_{PDCCH}^{max,(X,Y}^{ᵢ}^{),μ}, M_{PDCCH}^{total,(X,Y}^{ᵢ}^{),μ}
. . . results to PDCCH monitoring according to the combination (X,Yi) and any pair of spans in the set is within Y max symbols, where first X symbols start at a first symbol with a PDCCH monitoring occasion and next X symbols start at a first symbol with a PDCCH monitoring occasion that is not included in the first X symbols

In sum, for the second way: a span (X,Y)=(2,1), (4,1), (7,1) may be introduced, and how to select one (X,Y) from the one or more combinations because the maximum number (M,C) are the same for (X,Y1) and (X,2), if both (X,Y1) and (X,Y2) are reported by UE, may be according to the following options.
Option 1: Selecting one combination (X,Y). Any one of (X, Y1) and (X, Y2) is acceptable.
Option 2: Spec changed with additional condition, largest Y.
Option 3: Spec changed with additional condition, smallest Y.
   Further for Option 1, M_total may be changed with (1) change Y to Yi, (2) . . . results to PDCCH monitoring according to the combination (X,Yi) and any pair of spans in the set is within Yₘₐₓ symbols.

In order to reduce the complexity on URLLC span based PDCCH monitoring, a restriction on the maximum number of spans within a slot may be determined. That is, without a restriction on only permit 1OS CORESET duration, no restriction may absolutely preclude adjacent PDCCH monitoring occasions. One benefit is that it may reduce UE complexity for span based PDCCH monitoring while not need to introduce a new combination (X,Y).

In addition or alternatively, in some embodiments, the network 104 may configure a plurality of serving cells for a user device 102. Within the plurality of serving cells, there may be a primary cell (PCell). The network 104 may configure demodulation reference signal (DMRS) bundling for UL transmission for at least one of the plurality of serving cells. More specifically, the network 104 may configure DMRS bundling for a plurality of physical uplink shared channel (PUSCH) repetitions or physical uplink control channel (PUCCH) repetitions for at least one of the plurality of serving cells.

In addition, in some embodiments, the network 104 may configure a nominal time domain window (TDW) for a user device 102. In particular embodiments, the network 104 may configure the length of the nominal TDW. The configured length of the nominal TDW may indicate the length for the nominal TDW except the last nominal TDW. For example, the configured TDW may include a plurality of slots, or a plurality of PUSCH repetition transmissions or PUCCH transmissions.

In some embodiments, there may be one or more nominal TDWs for the plurality of PUSCH repetitions or PUCCH repetitions. The start of the first nominal TDW may be the first slot determined for the first PUSCH or PUCCH repetition transmission. The end of the last nominal TDW may be the last slot determined for the last PUSCH or PUCCH repetition. The start of any other nominal TDW may be the first slot determined for a PUSCH or PUCCH repetition transmission after the slot determined for the PUSCH or PUCCH repetition transmission of a previous nominal TDW.

In other embodiments, the start of the first nominal TDW may be the first PUSCH or PUCCH repetition. The end of the last nominal TDW may be the last PUSCH or PUCCH. The start of any other nominal TDW may be the first PUSCH or PUCCH repetition after the PUSCH or PUCCH repetition of a previous TDW.

A nominal TDW may include one or more actual TDWs. Within an actual TDW, the user device 102 may maintain the power consistency and phase continuity across a PUSCH transmission or a PUCCH transmission.

Also, the start of the first actual TDW may be the first symbol of the first PUSCH or PUCCH transmission in a slot determined for a PUSCH transmission or a PUCCH transmission within the nominal TDW. The end of an actual TDW may be the last symbol of the last PUSCH transmission repetition in a slot if the actual TDW reaches the end of the last PUSCH transmission with the nominal TDW. In other embodiments, if an event occurs which cause power consistency and phase continuity not to be maintained across a PUSCH transmission or a PUCCH transmission, the end of actual TDW may be the last symbol of a PUSCH transmission before the event (e.g., the last symbol of the last PUSCH transmission before the event).

Additionally, in some embodiments, the start of an actual TDW may be the first symbol of a PUSCH transmission or a PUCCH transmission after the event which causes power consistency and phase continuity not to be maintained across PUSCH transmission or PUCCH transmission. Additionally or alternatively, the start of the actual TDW may be the first symbol of the first PUSCH transmission or first PUCCH transmission overlapping with the event which causes power consistency and phase continuity not to be maintained across a PUSCH transmission or a PUCCH transmission. The event may overlap with the PUSCH transmission or the PUCCH transmission in the time domain.

In some embodiments, for a PUSCH transmission or a PUCCH transmission in a first cell, an event, which may cause power consistency and phase continuity not to be maintained across the PUSCH transmission or the PUCCH transmission, may include an UL transmission in a second cell between two consecutive PUSCH transmissions or PUCCH transmissions.

In some embodiments, for a PUSCH transmission or a PUCCH transmission in a first cell, an event which may cause power consistency and phase continuity not to be maintained across the PUSCH transmission or the PUCCH transmission may include a first UL transmission in a second cell. Additionally or alternatively, for the PUSCH transmission or the PUCCH transmission in the first cell, an event which may cause power consistency and phase continuity not to be maintained across the PUSCH transmission or the PUCCH transmission may include the first UL transmission in the second cell if there is no previous transmission with higher priority than the PUSCH or the PUCCH within the recent actual TDW before the first UL transmission. The first UL transmission in the second cell may have a higher priority than the PUSCH transmission or the PUCCH transmission in the first cell.

Additionally or alternatively, for a PUSCH transmission or a PUCCH transmission in the first cell, an event which may cause power consistency and phase continuity not to be maintained across the PUSCH transmission or the PUCCH transmission may include a first UL transmission in a second cell if there is a previous transmission within the recent actual TDW. The previous transmission may cause a new actual TDW. The first UL transmission in the second cell may have a higher priority than the PUSCH transmission or the PUCCH transmission in the first cell. The first UL transmission and the previous transmission may have the different transmission power.

In some embodiments, for a PUSCH transmission or a PUCCH transmission in the first cell, an event which may cause power consistency and phase continuity not to be maintained across the PUSCH transmission or the PUCCH transmission may include the start (e.g., start boundary) of the first PUSCH transmission or the first PUCCH transmission that does not overlap with a second UL transmission in the second cell in the time domain. The second UL transmission may be within the recent actual TDW. The second UL transmission may cause a new actual TDW. The first PUSCH transmission or the first PUCCH transmission may be after the second UL transmission.

Additionally or alternatively, for a PUSCH transmission or a PUCCH transmission in the first cell, an event which may cause power consistency and phase continuity not to be maintained across the PUSCH transmission or the PUCCH transmission may include the start (e.g., start boundary) of the first PUSCH transmission or the first PUCCH transmission that does not overlap a third UL transmission in the second cell in the time domain. The third UL transmission may have a higher priority than the PUSCH transmission or the PUCCH transmission. The third UL transmission and the second UL transmission may have the same transmission power. The third UL transmission and the second UL transmission may both be within the recent actual TDW. The first PUSCH transmission or the first PUCCH transmission may be after the third UL transmission.

Additionally or alternatively, for the PUSCH transmission or the PUCCH transmission in the first cell, an event which may cause power consistency and phase continuity not to be maintained across the PUSCH transmission or the PUCCH transmission may include the start (e.g., start boundary) of the first PUSCH transmission or the first PUCCH transmission that does not overlap with the second UL transmission in the second cell in the time domain, and does not overlap with the third UL transmission in the second cell in the time domain.

For the channel transmission or signal transmission in the plurality of serving cells, the prioritization of the channel transmission or signal transmission may be defined as below in descending order.
1) Physical random access channel (PRACH) transmission on the PCell.
2) PUCCH or PUSCH transmissions with higher priority index.

For PUCCH or PUSCH transmissions with same priority index:
3.1) PUCCH transmission with hybrid automatic repeat request acknowledgement (HARQ-ACK) information, and/or scheduling request (SR), and/or link recovery request (LRR), or PUSCH transmission with HARQ-ACK information;
3.2) PUCCH transmission with channel state information (CSI) or PUSCH transmission with CSI;
3.3) PUSCH transmission without HARQ-ACK information or CSI and, for Type-2 random access procedure, PUSCH transmission on the PCell.
4) sounding reference signal (SRS) transmission, with aperiodic SRS having higher priority than semi-persistent and/or periodic SRS, or PRACH transmission on a serving cell other than the PCell.

For example, the PRACH transmission on the PCell may always have the highest priority. The PUCCH transmission may have a higher priority than the PUSCH transmission with channel state information (CSI) if they have the same priority index.

Additionally, in case of the same priority order and for operation with carrier aggregation, the user device 102 may prioritize power allocation for transmissions on the primary cell over transmissions on a secondary cell.

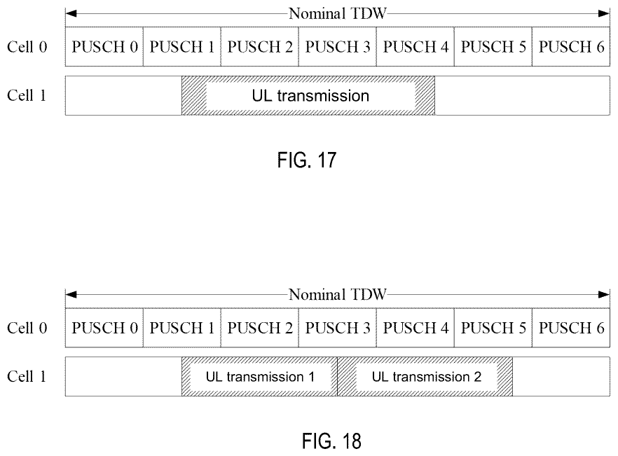

FIG. 17 shows an example of the actual TDW determination for the PUSCH in accordance with the embodiments. A user device 102 is configured with two serving cells, denoted by Cell 0 and Cell 1, respectively. In Cell 0, there are 7 PUSCH repetitions within a nominal TDW, denoted by PUSCH 0-6, respectively. An UL transmission is transmitted in Cell 1 and overlaps with PUSCH 1, PUSCH 2, PUSCH 3 and PUSCH 4 in the time domain.

In a first case, the UL transmission in Cell 1 has a lower priority than the PUSCH transmission in Cell 0. Within the nominal TDW, the start of the first actual TDW is the first symbol of the first PUSCH (e.g., PUSCH 0). Since the UL transmission has a lower priority than the PUSCH transmission, there is no event which causes power consistency and phase continuity not to be maintained across the PUSCH transmission. The end of the first actual TDW is the last symbol of the last PUSCH (e.g., PUSCH 6). Therefore, the actual TDW includes PUSCH 0-6.

In a second case, the UL transmission in Cell 1 has a higher priority than the PUSCH transmission in Cell 0. Within the nominal TDW, the start of the first actual TDW is the first symbol of the first PUSCH (e.g., PUSCH 0). Since the UL transmission has a higher priority than the PUSCH transmission and there is no previous transmission in Cell 1 with a higher priority than the PUSCH transmission before the UL transmission, the UL transmission is an event which causes power consistency and phase continuity not to be maintained across the PUSCH transmission. PUSCH 0 is the last PUSCH before the event. Therefore, the end of the first actual TDW is the last symbol of PUSCH 0. The first actual TDW includes only PUSCH 0.

Additionally, PUSCH 1 is the first PUSCH that overlaps with the UL transmission. Therefore, the first symbol of PUSCH 1 is the start of the second actual TDW. The UL transmission overlaps with PUSCH 1, PUSCH 2, PUSCH 3 and PUSCH 4 in the time domain. PUSCH 5 does not overlap with UL transmission in the time domain. This implies that PUSCH 5 is the first PUSCH that does not overlap with the UL transmission. Therefore, the start of the PUSCH 5 is an event which causes power consistency and phase continuity not to be maintained across the PUSCH transmission. Also, PUSCH 4 is the last PUSCH before the event. Therefore, the end of the second actual TDW is the last symbol of PUSCH 4. The second actual TDW includes PUSCH 1, PUSCH 2, PUSCH 3 and PUSCH 4.

After the event, PUSCH 5 is the first PUSCH. Therefore, the first symbol of PUSCH 5 is the start of the third actual TDW. There is no event until the end of the nominal TDW. Therefore, the end of the third actual TDW is the last symbol of PUSCH 6. The third actual TDW includes PUSCH 5 and PUSCH 6. FIG. 18 shows an example of the actual TDW determination for PUSCH in accordance with the embodiments. In Cell 1, there are two UL transmissions, denoted by UL transmission 1 and UL transmission 2, respectively. UL transmission 1 overlaps with PUSCH 1, PUSCH 2 and PUSCH 3 in the time domain. UL transmission 2 overlaps with PUSCH 3, PUSCH 4 and PUSCH 5 in the time domain.

In a first case, UL transmission 1 in Cell 1 has higher priority than the PUSCH transmission in Cell 0. UL transmission 2 in Cell 1 has a higher priority than the PUSCH transmission in Cell 0. UL transmission 1 and UL transmission 2 have the same transmission power.

Within the nominal TDW, the start of the first actual TDW is the first symbol of the first PUSCH (e.g., PUSCH 0). Similarly, the end of the first actual TDW is the last symbol of PUSCH 0 due to the event being UL transmission 1 with a higher priority than the PUSCH transmission. The first actual TDW includes PUSCH 0.

The start of the second actual TDW is the first symbol of PUSCH 1 since PUSCH 1 is the first PUSCH overlapping with the UL transmission 1 in the time domain. The second actual TDW is caused by the UL transmission 1. UL transmission 1 is the previous transmission of UL transmission 2. UL transmission 1 overlaps with PUSCH 1, PUSCH 2 and PUSCH 3 in the time domain. UL transmission 2 overlaps with PUSCH 3, PUSCH 4 and PUSCH 5 in the time domain. UL transmission 2 and UL transmission 1 have the same transmission power. PUSCH 6 does not overlap both UL transmission 1 and UL transmission 2 in the time domain. This implies that PUSCH 6 is the first slot that does not overlap with the second UL transmission in Cell 1 within the recent TDW that causes a new actual TDW, and does not overlap with a third UL transmission in the Cell 1 cell with a higher priority than PUSCH transmission and with the same transmission power as the first UL transmission. Therefore, the start boundary of the PUSCH 6 is an event. PUSCH 5 is the last PUSCH before the start of PUSCH 6. The end of the second actual TDW is the last symbol of PUSCH 5. The second actual TDW includes PUSCH 1, PUSCH 2, PUSCH 3, PUSCH 4, and PUSCH 5. After the event, there is only one PUSCH (e.g., PUSCH 6) within the nominal TDW. Then the third actual TDW includes PUSCH 6 only.

In a second case, UL transmission 1 in Cell 1 has a higher priority than a PUSCH transmission in Cell 0. UL transmission 2 in Cell 1 has a higher priority than the PUSCH transmission in Cell 0. UL transmission 1 and UL transmission 2 have different transmission power.

Similarly, the first actual TDW includes PUSCH 0 only due to the event being UL transmission 1 with a higher priority than the PUSCH transmission.

The start of the second actual TDW is the first symbol of PUSCH 1 since PUSCH 1 is the first PUSCH overlapping with the UL transmission 1. The second actual TDW includes the UL transmission 1. UL transmission 1 and UL transmission 2 have different transmission power. Additionally, UL transmission 2 has a higher priority than the PUSCH transmission in Cell 0. This implies that UL transmission 2 is an event. PUSCH 2 is the last PUSCH before the event. Therefore, the end of the second actual TDW is last symbol of PUSCH 2. The second actual TDW includes PUSCH 1 and PUSCH 2.

UL transmission 2 overlaps with PUSCH 3, PUSCH 4 and PUSCH 5 in the time domain. This implies that PUSCH 3 is the first PUSCH that overlaps with the event since UL transmission 2 is an event. Therefore, the start of a third actual TDW is the first symbol of PUSCH 3. PUSCH 6 does not overlap UL transmission 2 in the time domain. This implies that PUSCH 6 is the first slot that does not overlap with second UL transmission in Cell 1 with a higher priority than the PUSCH transmission. Therefore, the start boundary of PUSCH 6 is an event. PUSCH 5 is the last PUSCH before the event. The end of the third actual TDW is the last symbol of PUSCH 5. The third actual TDW includes PUSCH 3, PUSCH 4, and PUSCH 5. Similarly, the fourth actual TDW only includes PUSCH 6.

In a third case, UL transmission 1 in Cell 1 has a higher priority than the PUSCH transmission in Cell 0. UL transmission 2 in Cell 1 has a lower priority than the PUSCH transmission in Cell 0. UL transmission 1 and UL transmission 2 may have the same or different transmission power.

Similarly, the first actual TDW only includes PUSCH 0 due to the event being UL transmission 1 with a higher priority than the PUSCH transmission. The start of the second actual TDW is the first symbol of PUSCH 1 since PUSCH 1 is the first PUSCH overlapping with the UL transmission 1. UL transmission 1 overlaps with the PUSCH 1, PUSCH 2 and PUSCH 3 in the time domain. PUSCH 4 only overlaps with UL transmission 2. However, UL transmission in Cell 1 has a lower priority than the PUSCH transmission in Cell 0. This implies that PUSCH 4 is the first slot that does not overlap with the second UL transmission in Cell 1 within the recent TDW that causes a new actual TDW, and does not overlap with a third UL transmission in the Cell 1 cell with a higher priority than the PUSCH transmission and with the same transmission power as the first UL transmission. Therefore, the start boundary of PUSCH 4 is an event. Before the event, PUSCH 3 is the last PUSCH. The end of the second actual TDW is the last symbol of PUSCH 3. The actual TDW includes PUSCH 1, PUSCH 2 and PUSCH 3.

After the event, the first PUSCH is PUSCH 4. The start of the third actual TDW is the first symbol of PUSCH 4. There is no event until the end of the nominal TDW. Therefore, the end of the third actual TDW is the last symbol of PUSCH 6. The third actual TDW includes PUSCH 4, PUSCH 5 and PUSCH 6.

In a fourth case, UL transmission 1 in Cell 1 has a lower priority than the PUSCH transmission in Cell 0. UL transmission 2 in Cell 1 has a higher priority than the PUSCH transmission in Cell 0. UL transmission 1 and UL transmission 2 may have the same or different transmission power.

Within the nominal TDW, the start of the first actual TDW is the first symbol of the first PUSCH (e.g., PUSCH 0). UL transmission 1 has a lower priority than the PUSCH transmission. This implies that there is no previous transmission with a higher priority than the PUSCH transmission before UL transmission 2. The end of the first actual TDW is the last symbol of PUSCH 2 due to the event being UL transmission 2 with a higher priority than the PUSCH transmission. The first actual TDW includes PUSCH 0, PUSCH 1 and PUSCH 2.

UL transmission 2 overlaps with PUSCH 3, PUSCH 4 and PUSCH 5 in the time domain. The PUSCH 3 is the first PUSCH that overlaps with UL transmission 2. The start of the second actual TDW is the first symbol of PUSCH 3. PUSCH 6 does not overlap with UL transmission 2. Therefore, the start boundary of the PUSCH 6 is an event. Before the event, the last PUSCH is PUSCH 5. The end of the second actual TDW is the last symbol of PUSCH 5. The second actual TDW includes PUSCH 3, PUSCH 4 and PUSCH 5. Similarly, the third actual TDW only includes PUSCH 6.

In some embodiments, for a PUSCH transmission or a PUCCH transmission in a first cell, an event which may cause power consistency and phase continuity not to be maintained across the PUSCH transmission or the PUCCH transmission may include the start (e.g., start boundary) of a PUSCH transmission or a PUCCH transmission that has a different transmission power from the previous PUSCH transmission or PUCCH transmission.

In some embodiments, the network 104 may configure DMRS bundling for one of the plurality of serving cells. The serving cell configured with DMRS bundling may have the higher priority than all the other serving cells. This may imply that the UL transmission in the serving cell configured with DMRS bundling has a higher priority than the UL transmission on any other serving cell. The UL transmission may include at least one of PUCCH, PUSCH, SRS or PRACH.

Alternatively, the network 104 may configure the UL transmission in the serving cell configured with DMRS bundling having the highest priority. A user device 102 may allocate the transmission power for the UL transmission by assuming that the UL transmission in the serving cell configured with DMRS bundling has the highest priority.

With the embodiments, the user device 102 can support DMRS bundling for at least one of the serving cells under carrier aggregation operation. This can further improve the PUSCH or PUCCH performance in terms of reliability. In addition, uplink coverage can be improved.

In addition or alternatively, in some embodiments, the network 104 may configure a plurality of serving cells for a user device 102. The plurality of serving cells may be on the same or different bands.

The network 104 may schedule or configure a first transmission and a second transmission. The first transmission is transmitted on a first serving cell at a first time. The second transmission is transmitted on a second serving cell at a second time. The first transmission may be prior to the second transmission. There may be a switching period between the first transmission and the second transmission. The network 104 may configure the switching period to be on the first serving cell or on the second serving cell. During the switching period, the user device 102 may not perform any transmission or reception. This may imply that if an uplink transmission on any one of the plurality of serving cells overlaps with the switching period in the time domain, the uplink transmission may be dropped or canceled.

In addition, there may be a plurality of slots, sub-slot, or OFDM symbols between the first transmission and the second transmission. The switching period may be on the one or more of the plurality of slots, sub-slots or OFDM symbols. The location of the switching period (e.g., in which slot, sub-slot, or symbol the switching period is located) may be configured (or indicated) by the network 104 or specified by the protocol.

In some embodiments, the switching period may be on the slot of the first transmission or on the next slot of the first transmission. More specifically, the switching period may be on the slot of the first transmission and after the first transmission. The switching period may be on the start of the next slot of the first transmission.

In some embodiments, the switching period may be on the slot of the second transmission or on the previous slot of the second transmission. More specifically, the switching period may be on the slot of the second transmission and before the second transmission. Alternatively, the switching period may be on the end of the next slot of the second transmission.

In some embodiments, the network 104 may indicate the slot, sub-slot, or symbol of the switching period. For example, the network may indicate that the switching period on the first slot after the first transmission via downlink control information (DCI), medium access control (MAC) control element (CE), or radio resource control (RRC) signaling.

The network 104 may schedule or configure a third transmission on a third serving cell. If the third transmission overlaps with the switching period in the time domain, the user device 102 may cancel or drop the third transmission.

Additionally, in some embodiments, for a PUSCH transmission or a PUCCH transmission in a serving cell, an event which may cause power consistency and phase continuity not to be maintained across PUSCH transmission or PUCCH transmission may include the switching period.

In some embodiments, for a PUSCH transmission or a PUCCH transmission in a serving cell, an event which may cause power consistency and phase continuity not to be maintained across PUSCH transmission or PUCCH transmission may include the start (e.g., start boundary) of the first PUSCH transmission or PUCCH transmission that does not overlap with the switching period. The first PUSCH transmission or PUCCH transmission may be after the switching period.

In some embodiments, all of the PUSCH transmissions or PUCCH transmissions on the plurality of slots, sub-slots or OFDM symbols may be in the separate actual TDW. This implies that each actual TDW may only include one PUSCH transmission or PUCCH transmission for these PUSCH transmission or PUCCH transmission on the plurality of slots, sub-slots or OFDM symbols.

With these embodiments, the location of the switching period is determined. The network 104 and the user device have the same understanding on the location of switching period as well as the overlapping between uplink transmission and the switching period. The network 104 can determine which uplink transmission is dropped or canceled by the user device 102.

In some embodiments, the network 104 may configure a serving cell for a user device 102. The serving cell may include an uplink carrier and a downlink carrier. The uplink carrier and the downlink carrier may be coupled in TDD manner or FDD manner. The network 104 may further configure a supplementary uplink carrier for the serving cell for the user device 102. This may imply that the serving cell includes two uplink carriers. One is a normal uplink carrier and the other one is a supplementary uplink carrier. The network 104 may configure PUCCH on one of the uplink carriers. This may imply that the PUCCH may be transmitted on the one of the uplink carriers. The uplink carrier configured with PUCCH may have a higher priority than the other uplink carrier. That is to say the UL transmission on the uplink carrier configured with PUCCH may have a higher priority than the UL transmission on the other uplink carrier. For example, the network 104 may configure PUCCH on the supplementary uplink carrier. Then, the supplementary uplink carrier may have a higher priority than the normal uplink carrier. The UL transmission on the supplementary uplink carrier may have a higher priority than the UL transmission on the normal uplink carrier. In case both of the two carrier are not configured with PUCCH, the normal uplink carrier may have the higher priority than the supplementary uplink carrier.

In some embodiments, the network 104 may configure DMRS bundling for UL transmission (e.g., PUSCH transmission or PUCCH transmission) only for the uplink carrier with higher priority. From the perspective of the user device 102, the user device 102 may expect that the DMRS bundling is configured for the uplink carrier with higher priority (e.g., the uplink carrier configured with PUCCH if one of the uplink carriers is configured with PUCCH, or normal uplink carrier, otherwise).

In some embodiments, the network 104 may configure DMRS bundling for UL transmission on the normal uplink carrier or on the supplementary uplink carrier. For a PUSCH transmission or a PUCCH transmission in the first carrier, an event which may cause power consistency and phase continuity not to be maintained across PUSCH transmission or PUCCH transmission may include an UL transmission in a second carrier between two consecutive PUSCH transmissions or PUCCH transmissions.

In some embodiments, for a PUSCH transmission or a PUCCH transmission in the first carrier, an event which may cause power consistency and phase continuity not to be maintained across the PUSCH transmission or the PUCCH transmission may include a first UL transmission in a second carrier. In some embodiments, for a PUSCH transmission or a PUCCH transmission in the first carrier, an event, which may cause power consistency and phase continuity not to be maintained across the PUSCH transmission or the PUCCH transmission, may include the first UL transmission in a second carrier if there is no previous transmission in the second carrier before the first UL transmission within the recent actual TDW.

Additionally or alternatively, for a PUSCH transmission or a PUCCH transmission in the first carrier, an event, which may cause power consistency and phase continuity not to be maintained across PUSCH transmission or PUCCH transmission, may include the first UL transmission in a second carrier if there is a previous UL transmission in the second carrier within the recent actual TDW. The previous UL transmission may cause the recent actual TDW. The previous UL transmission may be prior to the first UL transmission. The first UL transmission may have the different transmission power from the previous UL transmission. In some embodiments, the first UL transmission may overlap with the PUSCH transmission or the PUCCH transmission in the time domain. In some embodiments, the second UL carrier may have a higher priority than the first UL carrier. In some embodiments, the first UL transmission in the second UL carrier may have a higher priority than the PUSCH transmission or PUCCH transmission in the first UL carrier. The previous UL transmission on the second carrier may have a higher priority than the PUCCH transmission or PUSCH transmission in the first carrier.

In some embodiments, for a PUSCH transmission or a PUCCH transmission in the first carrier, an event, which may cause power consistency and phase continuity not to be maintained across PUSCH transmission or PUCCH transmission, may include the start (e.g., start boundary) of the first PUSCH transmission or PUCCH transmission that does not overlap with a second UL transmission on the second carrier. The second UL transmission may be within the recent actual TDW. The second UL transmission may cause a new actual TDW. The first PUSCH transmission or the first PUCCH transmission may be after the second UL transmission.

Additionally or alternatively, for a PUSCH transmission or a PUCCH transmission in the first carrier, an event which may cause power consistency and phase continuity not to be maintained across the PUSCH transmission or the PUCCH transmission may include the start (e.g., start boundary) of the first PUSCH transmission or PUCCH transmission that does not overlap with a third UL transmission in the second carrier in the time domain. The third UL transmission may have a higher priority than the PUSCH transmission or PUCCH transmission. The third UL transmission and the second UL transmission may have the same transmission power. The third UL transmission and the second UL transmission may both be within the recent actual TDW. The first PUSCH transmission or the first PUCCH transmission may be after the third UL transmission.

Additionally or alternatively, for a PUSCH transmission or a PUCCH transmission in the first carrier, an event, which may cause power consistency and phase continuity not to be maintained across PUSCH transmission or PUCCH transmission, may include the start (e.g., start boundary) of the PUSCH transmission or the PUCCH transmission that does not overlap with the second UL transmission on the second carrier and does not overlap with the third UL transmission in the time domain.

In some embodiments, the second carrier may have a higher priority than the first carrier. The second transmission may be prior to the third UL transmission. The second UL transmission on the second carrier may have a higher priority than the PUSCH transmission or PUCCH transmission in the first carrier. The third UL transmission on the second carrier may have a higher priority than the PUSCH transmission or PUCCH transmission in the first carrier. The first carrier may be a normal uplink carrier or a supplementary uplink carrier. The second carrier may be a normal uplink carrier or a supplementary uplink carrier.

In some embodiments, the network 104 may configure DMRS bundling for UL transmission for one of the uplink carriers. The uplink carrier configured with DMRS bundling may have a higher priority than the uplink carrier without being configured with DMRS bundling.

In some embodiments, a user device 102 may not support the simultaneous transmission on the normal uplink carrier and supplementary uplink carrier. The user device 102 may drop the UL transmission on the uplink carrier with a lower priority in case the UL transmissions on the two uplink carriers overlap with each other. This implies that the user device 102 may only transmit the UL transmission on the uplink carrier with higher priority. Alternatively, the user device 102 may drop the SRS transmission in case UL transmissions on the two uplink carriers overlap with each other. This implies that the user device 102 may only transmit the UL transmission other than SRS.

With these embodiments, the user device 102 can support DMRS bundling for the serving cell configured with supplementary uplink carrier. This can further improve the PUSCH or PUCCH performance in terms of reliability. In addition, uplink coverage can be improved.

In some embodiments, the network 104 may configure a plurality of cell groups (CGs) for the user device 102. Each CG may include a plurality of serving cells. The network 104 may configure DMRS bundling for an UL transmission (e.g., a PUSCH transmission or a PUCCH transmission) for at least one serving cell in one CGs.

In some embodiments, for a PUSCH transmission or a PUCCH transmission in the first CG, an event, which may cause power consistency and phase continuity not to be maintained across PUSCH transmission or PUCCH transmission, may include the UL symbol or flexible symbol of a second CG. The UL symbol or flexible symbol of the second CG may be configured by the network 104 via RRC signaling or a DCI.

In some embodiments, for a PUSCH transmission or a PUCCH transmission in the first CG, an event, which may cause power consistency and phase continuity not to be maintained across PUSCH transmission or PUCCH transmission, may include the start of the first PUSCH or the first PUCCH that does not overlap with any UL or flexible symbols of the second CG. The first PUSCH or the first PUCCH may be after the UL symbol or the flexible symbol.

In some embodiments, a PUSCH transmission or a PUCCH transmission in the first CG may overlap with the UL symbol, slot, or sub-frame in the second CG. The user device 102 may cancel (or drop) the PUSCH transmission or the PUCCH transmission in the first CG. For a PUSCH transmission or a PUCCH transmission in the first CG, an event, which may cause power consistency and phase continuity not to be maintained across PUSCH transmission or PUCCH transmission, may include the PUSCH cancellation or the PUCCH cancellation due to overlapping with the UL symbol, slot, or sub-frame in the second CG.

With these embodiments, a user device 102 can support DMRS bundling for at least one of the serving cells under dual connectivity operation. This can further improve the PUSCH or PUCCH performance in terms of reliability. In addition, uplink coverage can be improved.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: determining, by a communication device, a switching gap based on at least one switching period of at least one band pair of at least three bands involved in an uplink (UL) transmitter (Tx) switching; and transmitting, by a user device, an UL transmission after the UL Tx switching according to the switching gap.

A second aspect includes a method for wireless communication that includes: determining, by a communication device, a switching gap based on at least one switching period of at least one band pair of at least three bands involved in an uplink (UL) transmitter (Tx) switching; and receiving, by a network device, an UL transmission after a preceding UL transmission based on a switching gap.

A third aspect includes any of the first or second aspects, and further includes wherein the communication device is the user device or the network device.

A fourth aspect includes any of the first through third aspects, and further includes wherein the at least one band pair comprises only one band pair, and wherein the UL Tx switching comprises at least one of: only one transmitter switches from a first band to a second band of the only one band pair; one transmitter on one band that is not part of the only one band pair does not switch to a different band; or a first transmitter switches from the first band to the second band of the only one band pair, and a second transmitter stays on a third band not part of the only one band pair.

A fifth aspect includes the fourth aspect, and further includes wherein the switching gap is equal to the switching period of the only one band pair.

A sixth aspect includes any of the fourth or fifth aspects, and further includes wherein the UL Tx switching comprises at least one of: switching from one port on the first band and one port on the third band to one port on the second band and one port on the third band; or switching from one port on the first band and one port on the third band to one port on the second band.

A seventh aspect includes any of the first through third aspects, and further includes wherein the at least one band pair comprises a plurality of band pairs, wherein the at least one switching period comprises a plurality of switching periods of the plurality of band pairs, and wherein each band pair of the plurality of band pairs comprises two bands of the at least three bands between which a transmitter switches during the UL Tx switching.

An eighth aspect includes the seventh aspect, and further includes wherein the switching gap is based on at least one of a maximum switching period or a sum of the plurality of switching periods.

A ninth aspect includes any of the seventh or eighth aspects, and further includes wherein the UL Tx switching comprises at least one of: switching a first transmitter from a first band to a third band and switching a second transmitter from a second band to the third band; switching a first transmitter from a third band to a first band and switching a second transmitter from the third band to a second band; switching a first transmitter from a first band to a third band and switching a second transmitter from a second band to a fourth band; or switching a first transmitter from a third band to a first band and switching a second transmitter from a fourth band to a second band.

A tenth aspect includes the ninth aspect, and further includes wherein a first band pair of the plurality of band pairs comprises the first and third bands and a second band pair of the plurality of band pairs comprises the second and third bands, or a first band pair of the plurality of band pairs comprises the first and third bands and a second band pair of the plurality of band pairs comprises the second and fourth bands.

An eleventh aspect includes the ninth aspect, and further includes wherein switching from the second band to the third band is not allowed, and wherein a band pair of the plurality of band pairs comprises the first and second bands.

A twelfth aspect includes any of the seventh through eleventh aspects, and further includes wherein the UL Tx switching comprises at least one of: switching from one port on the first band and one port on the second band to two ports on the third band; switching from two ports on the third band to one port on the first band and one port on the second band; switching from one port on the first band and one port on the second band to one port on the third band and one port on the fourth band; or switching from one port on the third band and one port on the fourth band to one port on the first band and one port on the second band.

A thirteenth aspect includes any of the first through twelfth aspects, and further includes wherein preparation procedure time is increased in response to at least one: the UL Tx switching involves at least one band that is not part of a band pair reported by the user device; the UL Tx switching involves at least three bands, and at least one of the at least three bands before or after the UL Tx switching is an anchor band; or a report of a band combination includes that more preparation procedure time is needed.

A fourteenth aspect includes the thirteenth aspect, and further includes wherein the report of the band combination that includes that more preparation procedure time is needed further comprises more preparation procedure time is needed for all or at least some of a plurality of switching cases involving at least three bands available to the user device to perform the UL Tx switching.

A fifteenth embodiment includes any of the thirteenth or fourteenth embodiments, and further includes wherein at least some switching cases within at least three bands comprises at least one of: switching from one port on a first band and one port on a second band to two ports on a third band; switching from two ports on the third band to one port on the first band and one port on the second band; switching from one port on the first band and one port on the second band and one port on the third band and one port on the fourth band; or switching from one port on the third band and one port on the fourth band to one port on the first band and one port on the second band.

A sixteenth aspect includes a method for wireless communication that includes: determining, by a user device, a restriction for a PDCCH monitoring capability; and reporting, by the user device, a UE capability of the PDCCH monitoring capability with the restriction.

A seventeenth aspect includes the sixteenth aspect, and further includes wherein the restriction comprises at least one: adjacent PDCCH monitoring occasions are allowed to be configured and the user device will discard partial adjacent PDCCH monitoring occasions; a maximum number of adjacent spans or PDCCH monitoring occasions; a maximum number of spans or PDCCH monitoring occasions within a slot is defined; the same maximum number of DL and UL unicast DCI formats is relaxed from in one span to in two or more adjacent spans; or one or more scaled (M,C) value is introduced, wherein M is a maximum number of monitored physical downlink control channel (PDCCH) candidates per span, and C is a maximum number of non-overlapped control channel elements (CCEs) per span.

An eighteenth aspect includes any of the sixteenth or seventeenth aspects, and further includes wherein the restriction is applied for a combination (2,2) at least for when there is one span with a duration equal to 2 orthogonal frequency-division multiplexing (OFDM) symbols.

A nineteenth aspect includes a wireless communications apparatus comprising a processor and a memory, wherein the processor is configured to read code from the memory to implement any of the first through eighteenth aspects.

A twentieth aspect includes a computer program product comprising a computer-readable program medium comprising code stored thereupon, the code, when executed by a processor, causing the processor to implement any of the first through eighteenth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
determining, by a communication device, a switching gap based on at least one switching period of at least one band pair of at least three bands involved in one uplink (UL) switching; and
transmitting, by a user device, at least one UL transmission after the UL switching according to the switching gap.

2. The method of claim 1, wherein the user device transmitting the at least one UL transmission after the UL switching according to the switching gap comprises: the user device not transmitting the at least one UL transmission on any carrier for a duration of the switching gap.

3. The method of claim 1, wherein the communication device is the user device or the network device.

4. The method of claim 1, wherein the at least one band pair comprises only one band pair, and wherein the UL switching comprises at least one of:
only one transmitter switches from a first band to a second band of the only one band pair;
one transmitter on one band that is not part of the only one band pair does not switch to a different band; or
a first transmitter switches from the first band to the second band of the only one band pair, and a second transmitter stays on a third band not part of the only one band pair.

5. The method of claim 4, wherein the switching gap is equal to the switching period of the only one band pair.

6. The method of claim 4, wherein the UL switching comprises at least one of:
switching from one port on the first band and one port on the third band to one port on the second band and one port on the third band; or
switching from one port on the first band and one port on the third band to one port on the second band.

7. The method of claim 1, wherein the at least one band pair comprises a plurality of band pairs, wherein the at least one switching period comprises a plurality of switching periods of the plurality of band pairs, and wherein each band pair of the plurality of band pairs comprises two bands of the at least three bands between which a transmitter switches during the UL switching.

8. The method of claim 7, wherein the switching gap is based on a maximum switching period of the plurality of switching periods.

9. The method of claim 7, wherein the UL switching comprises at least one of:
switching a first transmitter from a first band to a third band and switching a second transmitter from a second band to the third band;
switching a first transmitter from a third band to a first band and switching a second transmitter from the third band to a second band;
switching a first transmitter from a first band to a third band and switching a second transmitter from a second band to a fourth band; or
switching a first transmitter from a third band to a first band and switching a second transmitter from a fourth band to a second band.

10. The method of claim 9, wherein a first band pair of the plurality of band pairs comprises the first and third bands and a second band pair of the plurality of band pairs comprises the second and third bands, or a first band pair of the plurality of band pairs comprises the first and third bands and a second band pair of the plurality of band pairs comprises the second and fourth bands.

11. The method of claim 7, wherein the UL switching comprises at least one of:
switching from one port on the first band and one port on the second band to two ports on the third band;
switching from two ports on the third band to one port on the first band and one port on the second band;
switching from one port on the first band and one port on the second band to one port on the third band and one port on the fourth band; or
switching from one port on the third band and one port on the fourth band to one port on the first band and one port on the second band.

12. The method of claim 1, wherein preparation procedure time is increased in response to at least one:
the UL switching involves at least one band that is not part of a band pair reported by the user device;
the UL switching involves at least three bands, and at least one of the at least three bands before or after the UL switching is an anchor band; or
a report of a band combination includes that more preparation procedure time is needed.

13. The method of claim 12, wherein the report of the band combination that includes that more preparation procedure time is needed further comprises more preparation procedure time is needed for all or at least some of a plurality of switching cases involving at least three bands available to the user device to perform the UL switching.

14. The method of claim 12, wherein at least some switching cases within at least three bands comprises at least one of:
switching from one port on a first band and one port on a second band to two ports on a third band;
switching from two ports on the third band to one port on the first band and one port on the second band;
switching from one port on the first band and one port on the second band and one port on the third band and one port on the fourth band; or
switching from one port on the third band and one port on the fourth band to one port on the first band and one port on the second band.

15. A method for wireless communication, the method comprising:
determining, by a communication device, a switching gap based on at least one switching period of at least one band pair of at least three bands involved in an uplink (UL) transmitter (Tx) switching; and
receiving, by a network device, an UL transmission after a preceding UL transmission based on a switching gap.

16. The method of claim 15, wherein the communication device is the user device or the network device.

17. The method of claim 15, wherein the at least one band pair comprises only one band pair, and wherein the UL Tx switching comprises at least one of:
only one transmitter switches from a first band to a second band of the only one band pair;
one transmitter on one band that is not part of the only one band pair does not switch to a different band; or
a first transmitter switches from the first band to the second band of the only one band pair, and a second transmitter stays on a third band not part of the only one band pair.

18. The method of claim 17, wherein the switching gap is equal to the switching period of the only one band pair.

19. The method of claim 17, wherein the UL Tx switching comprises at least one of:
switching from one port on the first band and one port on the third band to one port on the second band and one port on the third band; or
switching from one port on the first band and one port on the third band to one port on the second band.

20. A wireless communications apparatus comprising:
a memory storing a plurality of instructions; and
a processor configured to execute the plurality of instructions, and upon execution of the plurality of instructions is configured to cause the wireless communications apparatus to:
determine a switching gap based on at least one switching period of at least one band pair of at least three bands involved in an uplink (UL) switching; and
communicate an UL transmission after the UL Tx switching according to the switching gap.
